(19) United States
(12) Patent Application Publication
(10) Pub. No.: US 2006/0026213 A1
(43) Pub. Date: Feb. 2, 2006

(54) Content and portal systems and associated methods

(75) Inventors: David Yaskin, Arlington, VA (US); Heather Natour, Alexandria, VA (US); Zahra Safavian, Fairfax Station, VA (US); Tom Joyce, Arlington, VA (US); William H. Langford, Washington, DC (US); Daniel Cane, Washington, DC (US); Timothy Chi, Cambridge, MA (US); Stephanie Marie Cupp, Alexandria, VA (US); Anita Kaur Bhorjee, Baltimore, MD (US); Jessica Finnefrock, Alexandria, VA (US); Deborah Everhart, Washington, DC (US)

Correspondence Address: WILMER CUTLER PICKERING HALE AND DORR LLP, 60 STATE STREET, BOSTON, MA, 02109, US

(73) Assignee: Blackboard Inc., Washington, DC (US)

(21) Appl. No.: 11/142,965

(22) Filed: Jun. 2, 2005

Related U.S. Application Data
(60) Provisional application No. 60/576,150, filed on Jun. 2, 2004.
(60) Provisional application No. 60/576,179, filed on Jun. 2, 2004.

(51) Int. Cl. G06F 17/30

(52) U.S. Cl. 707/200

(57) ABSTRACT

A method and system are disclosed for providing a community of users access to content items. The content items relate to a plurality of courses, with each user being associated with one or more of the courses. A method of managing and controlling access to the content items can include the steps of (a) receiving from one or more of the users proposed content items for inclusion in a content repository; (b) selecting content items from the proposed content items for inclusion in the content repository; (c) specifying which of the users are eligible to access which of the content items in the content repository; and (d) providing access to content items in the repository over a network to users specified to have access to given content items.

### RELATED APPLICATIONS

The present application is based on and claims priority from U.S. provisional patent application Ser. No. 60/576,150 filed on Jun. 2, 2004 and entitled “CONTENT SYSTEM LEARNING OBJECTS,” which is incorporated by reference herein in its entirety. The present application is also based on and claims priority from U.S. provisional patent application Ser. No. 60/576,179 filed on Jun. 2, 2004 and entitled “PORTAL SYSTEM,” which is also incorporated by reference herein in its entirety.

### FIELD OF THE INVENTION

The present application relates generally to networks for exchanging information among persons in a community and, more particularly, to networks for exchanging information between instructors and students in an educational setting.

### BACKGROUND OF THE INVENTION

In educational settings, electronic networks are often used for exchanging information between instructors and students. Instructors can interact with one or more students by transmitting course lectures, literature, and other course materials, receiving student questions and input, and conducting participatory class discussions and examinations over networks such as local area networks and the Internet.

### BRIEF SUMMARY OF EMBODIMENTS OF THE INVENTION

In accordance with one or more embodiments of the invention, a method and system are disclosed for providing a community of users access to content items. The content items relate to a plurality of courses, with each user being associated with one or more of the courses. A method of managing and controlling access to the content items can include the steps of (a) receiving from one or more of the users proposed content items for inclusion in a content repository; (b) selecting content items from the proposed content items for inclusion in the content repository; (c) specifying which of the users are eligible to access which of the content items in the content repository; and (d) providing access to content items in the repository over a network to users specified to have access to given content items.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a block diagram illustrating implementation of a content system in a network in accordance with one or more embodiments of the invention;

FIG. 2 is an exemplary screenshot of a university portal from which the content system can be accessed;

FIG. 3 is an exemplary screenshot illustrating the addition of content to a course in accordance with one or more embodiments of the invention;

FIG. 4 is an exemplary screenshot illustrating searching for content items in the content system in accordance with one or more embodiments of the invention;

FIG. 5 is an exemplary screenshot of a workflow page for transferring content in accordance with one or more embodiments of the invention;

FIG. 6 is an exemplary screenshot of a page for managing workflow activities in accordance with one or more embodiments of the invention;

FIG. 7 is an exemplary screenshot illustrating permission management in accordance with one or more embodiments of the invention;

FIG. 8 is an exemplary screenshot of a directory listing in accordance with one or more embodiments of the invention;

FIG. 9 is an exemplary screenshot illustrating the addition of a content item in accordance with one or more embodiments of the invention;

FIG. 10 is an exemplary screenshot illustrating the setting of properties for added content in accordance with one or more embodiments of the invention;

FIG. 11 is an exemplary screenshot illustrating management of versions of a document or file in accordance with one or more embodiments of the invention;

FIG. 12 is an exemplary screenshot illustrating file tracking in accordance with one or more embodiments of the invention.

FIG. 13 is an exemplary screenshot of a student portfolio;

FIG. 14 is an exemplary screenshot of a portfolio of a faculty member;

FIG. 15 is an exemplary screenshot illustrating addition of content items on reserve in accordance with one or more embodiments of the invention;

FIG. 16 is an exemplary screenshot of an instructor home page;

FIG. 17 is an exemplary screenshot illustrating searching for a content item in accordance with one or more embodiments of the invention;

FIG. 18 is an exemplary screenshot illustrating searching for a content item in accordance with one or more embodiments of the invention;

FIG. 19 is an exemplary screenshot illustrating addition of a link to a content item;

FIG. 20 is an exemplary screenshot illustrating a user home page;

FIG. 21 is an exemplary screenshot illustrating link verification in accordance with one or more embodiments of the invention; and

FIG. 22 is an exemplary screenshot illustrating link repair in accordance with one or more embodiments of the invention.

FIG. 23 is an exemplary screenshot for managing brands for a portal system.

FIG. 24 is an exemplary screenshot for modifying brand properties for a portal system.

FIG. 25 is an exemplary screenshot for customizing brand contents a portal system.

FIG. 26 is an exemplary screenshot for managing institutional roles for system users of a portal system.

FIG. 27 is an exemplary screenshot for modifying institutional roles for system users of a portal system.

FIG. 28 is an exemplary screenshot for managing multiple and secondary roles for a system users of a portal system.

FIG. 29 is an exemplary screenshot for institutional staff associated with a portal system.

FIG. 30 is an exemplary screenshot illustrating management of catalog settings in accordance with one or more embodiments of the invention;

FIG. 31 is an exemplary screenshot illustrating selection of catalog administrators or managers in accordance with one or more embodiments of the invention; and

FIG. 32 is an exemplary screenshot illustrating management of catalog records in accordance with one or more embodiments of the invention.

### DETAILED DESCRIPTION OF PREFERRED EMBODIMENTS

The present invention is generally directed to a content system for use in the exchange of information by a community of persons over an electronic network such as, e.g., a local area network (LAN), a wide area network (WAN), a metropolitan area network (MAN), intranets, the Internet and/or the World Wide Web. The users of the content system can be persons associated with an organization such as, e.g., students and faculty at a college or employees of a corporate organization or other business. The content system is particularly suited for use in a university or college campus environment as illustrated in some of the examples described herein. It should, however, be understood that content systems in accordance with various embodiments of the invention can be implemented in various other organization and community settings, including, e.g., in other educational organizations such as K-12 schools, corporate and other business entities, and governmental institutions.

As described below, in an educational setting, the content system in accordance with one or more embodiments of the invention can allow faculty, instructors, and students and others to share and re-use content objects, search and discover content objects, manage content more effectively through versioning and locking, combine content together to form powerful standards-based learning objects, create portfolios, integrate library content, and be used as a workflow tool.

A content system in accordance with one or more embodiments of the invention can be part of an educational system such as, e.g., that described in U.S. patent application Ser. No. 09/608,208 entitled “Internet-Based Education Support System And Methods,” which is incorporated by reference herein in its entirety.

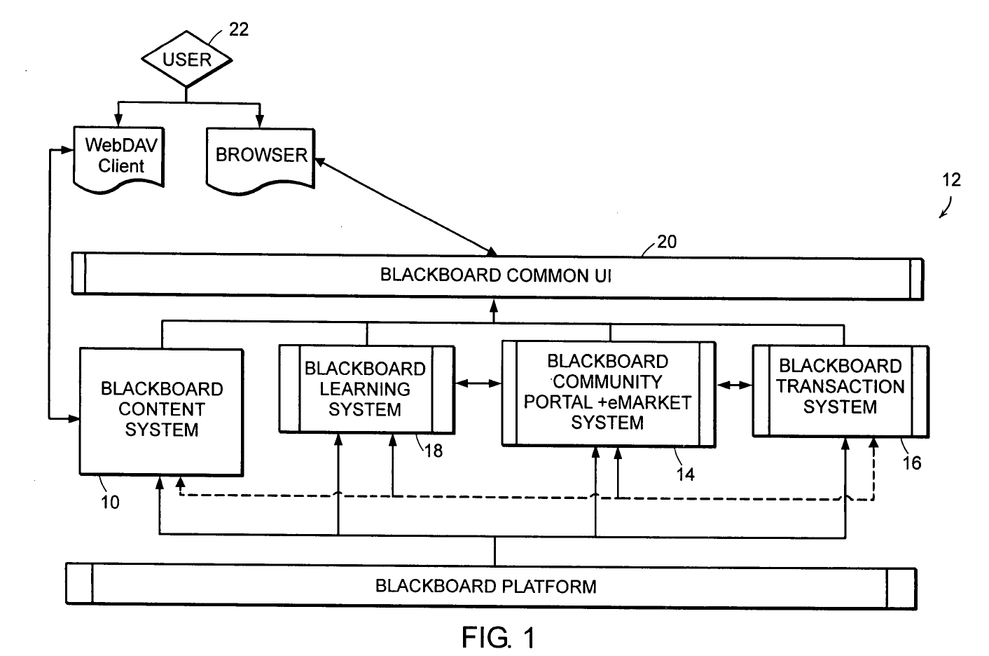

As shown in FIG. 1, a content system 10 in accordance with one or more embodiments of the invention can be integrated in an educational network 12 and can interact with other components of the network, including a portal system 14, a transaction system 16, and a learning system 18, provided, e.g., by Washington, D.C.-based Blackboard, Inc.

The learning system 18 can provide course management, course content, communication capabilities, tools such as digital drop boxes, and calendars.

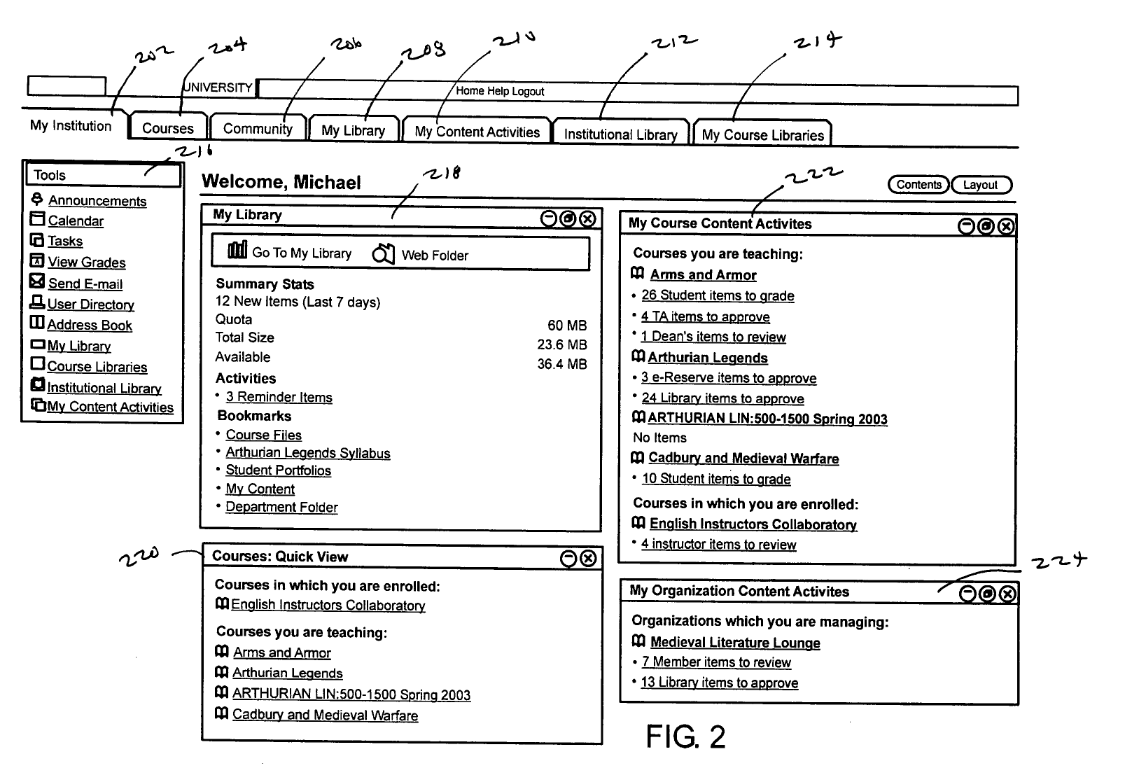

The portal system 14 can offer community portal environment that substantially unifies academics, commerce, communities, and administrative services online through one integrated interface. FIG. 2 is an exemplary screenshot of a university portal from which a student can access the educational network, including the content system, and other resources.

The transaction system 16 can provide operation of student identification, dining services, bookstore sales, campus commerce such as vending, laundry and copying, building access, as well as business with off-campus merchants. One example of a transaction system is disclosed in U.S. patent application Ser. No. 10/373,924 entitled “Method and System for Conducting Online Transactions,” which is incorporated by reference herein in its entirety.

In accordance with one or more embodiments of the invention, the content system can be integrated with one or more of such learning, portal and transactional systems using a common user interface 20 and shared authentication. Content within the content system can be generally seamlessly linked to the learning and portal systems, thereby enabling, e.g., reuse of content, tracking of content, and discrete access control. In addition, role integration can be provided whereby user roles (e.g., students, faculty, and administrators) within the learning system and the portal system are reflected and honored by the content system.

In accordance with one or more embodiments of the invention, the content system 10, portal system 14, transaction system 16, and learning system 18 can be implemented in a server system that communicates with a plurality of terminals or client devices operated by system users (typically, students, faculty, and administrators) over a network.

The client terminal devices operated by users are typically personal computers such as, e.g., Pentium-based desktop or notebook computers running a Windows operating system. Various other client terminal devices can also be used to communicate with the content system including, e.g., personal digital assistants (PDAs), cell phones and other wired or wireless electronic devices. As is well known, a representative personal computer includes a computer processing unit, memory, a keyboard, a pointing device such as a mouse or a touchpad, and a display unit. The screen of the display unit is used to present a graphical user interface (GUI) for the user. The GUI is supported by the operating system and allows the user to use a point and click method of input, e.g., by moving the mouse pointer on the display screen to an icon representing a data object at a particular location on the screen and pressing on the mouse buttons to perform a user command or selection. Also, one or more “windows” may be opened up on the screen independently or concurrently as desired. The client terminals typically include browsers, which are known software tools used to access Web servers. Representative browsers for personal computers include, among others, Netscape Navigator and Microsoft Internet Explorer.

The network can comprise a computer network such as, e.g., the Internet (particularly the World Wide Web), Intranets, LANs, WANs, MANs, or other networks, or some combination thereof.

As will be described in further detail, content systems in accordance with one or more embodiments of the invention can provide many benefits to users 22 of the system (e.g., students, faculty, and administrators), which can include one or more of the following.

Briefly, for instructors, the content system can provide a central place for storing course materials for reuse in multiple courses. It can be used by instructors to easily move content for various uses, e.g., for moving content across folders and content areas. The content system can provide simplified access to content via Web and WebDAV interfaces. It can also provide flexible access control. The content system can allow instructors to easily share course materials with other instructors. In addition, it can be used for locating materials for reuse. The content system can also be used for storing and sharing and searching for research and articles. In addition, the content system can allow instructors to create and share career portfolios. The content system can also be used as an online space for making research available to the public. The content system can, in addition, provide a secure encrypted method of sharing content.

For students, the content system can be used as personal disk space. It can be used as a storage for materials including homework, assignments, and research. The content system can be used to create and display portfolios for showing work and selected personal information to others inside and outside the institution. The content system can also be used for storing and sharing materials for group projects. It can also be used for storing and sharing of materials for student organizations. The content system can be used as an Internet based personal disk space, accessible anytime and anywhere. In addition, the content system can be used for submitting workflows for assignments and homework. The content system can also provide a secure encrypted method of sharing content.

For librarians, the content system can be used for storing electronic texts and research. E-reserves, copyright cleared course materials can be made available using the content system to users enrolled in specific classes. The content system can be used to make supplementary course materials available to instructors, organized by discipline, department, or course category. The content system can also provide content labeling and categorization. It can also be used to control who can use content and for what duration.

For IT administrators, the content system can provide a common structure for content storage rather than supporting multiple departmental and other inconsistent “local” storage systems. The content system can integrate with learning and portal systems. In addition, the content system can provide a common infrastructure for all courses, organizations, users, groups, etc., yet allow local customization of directory structures, sharing, naming conventions, with a good balance between overarching consistency and personal control. The content system can be used for reporting to track the who, when, and where of content storage in order to plan for growth and identify excessive use. The content system can control use and necessary expansion of a storage system through robust quota management. It can be used to control network use and for necessary expansion through robust bandwidth management. The content system can securely transfer sensitive data. It can be used for efficient file storage, and for scalable content management.

For a copyright officer, the content system can provide context for appropriate fair use practices, by controlling who has access to what content during a specific time period. The content system can also be used to assist institutions in complying with the TEACH Act by providing a framework for making materials available only to users who are enrolled in a course and only for the duration of the course. The content system can also be used to control access to materials copyrighted by the institution and its faculty and staff.

For the public affairs office of an institution, the content system can be used to provide a common repository of standard institutional images, logos, document templates, etc. for consistent use of the institutional identity. The content system can also be used to control who has access to standard institutional images, logos, etc. In addition, the content system can be used to update master copies of images, logos, etc. rather than tracking down copies of the original that may be scattered throughout the institution.

In accordance with one or more embodiments of the invention, the content system is integrated in an educational system that is readily adaptable to accommodate multiple languages. Such multi-language capability is advantageous for organizations having diverse user populations. An example of an education system with multi-language capability is described in U.S. patent application Ser. No. 10/443,149 entitled “Internet-Based Education Support System And Method With Multi-Language Capability,” which is incorporated by reference herein in its entirety.

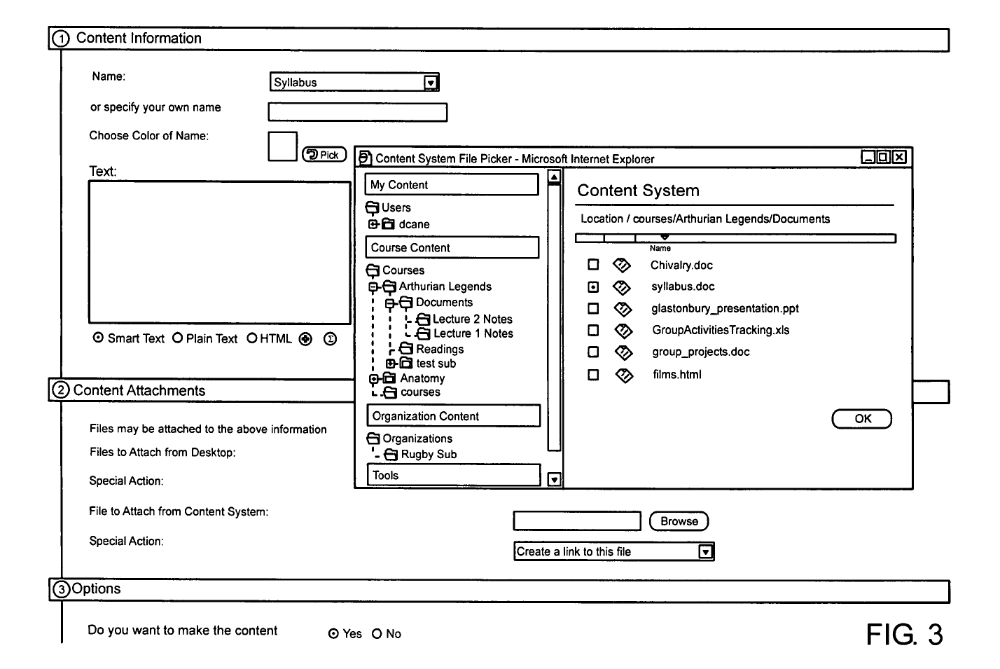

In accordance with one or more embodiments of the invention, the content system allows sharing, searching for and reusing content assets. Content can, e.g., be shared across courses, departments, users, and organizations. For example, in the past, a course instructor teaching multiple sections of a course would have to manage the course content for each section separately, which is time consuming and can create versioning problems with duplicated files. Using the content system, the instructor can efficiently manage the course content (e.g., make content changes, additions or deletions) at one source location (e.g., at a content repository) and link the content to separate course files for each of the sections. Accordingly, content items can be efficiently reused. FIG. 3 is an exemplary screenshot illustrating how content can be added to a course (i.e., a set of materials accessible to students enrolled in a given course).

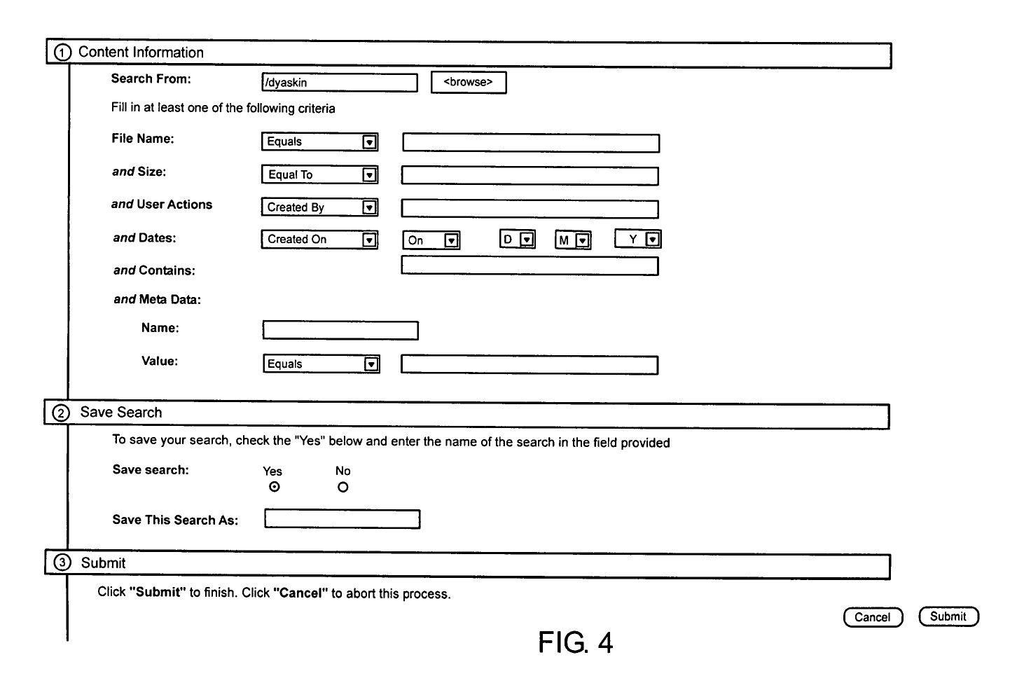

The content system can also allow content to be searched, e.g., by metadata and/or full text searching as illustrated in the exemplary screenshot of FIG. 4.

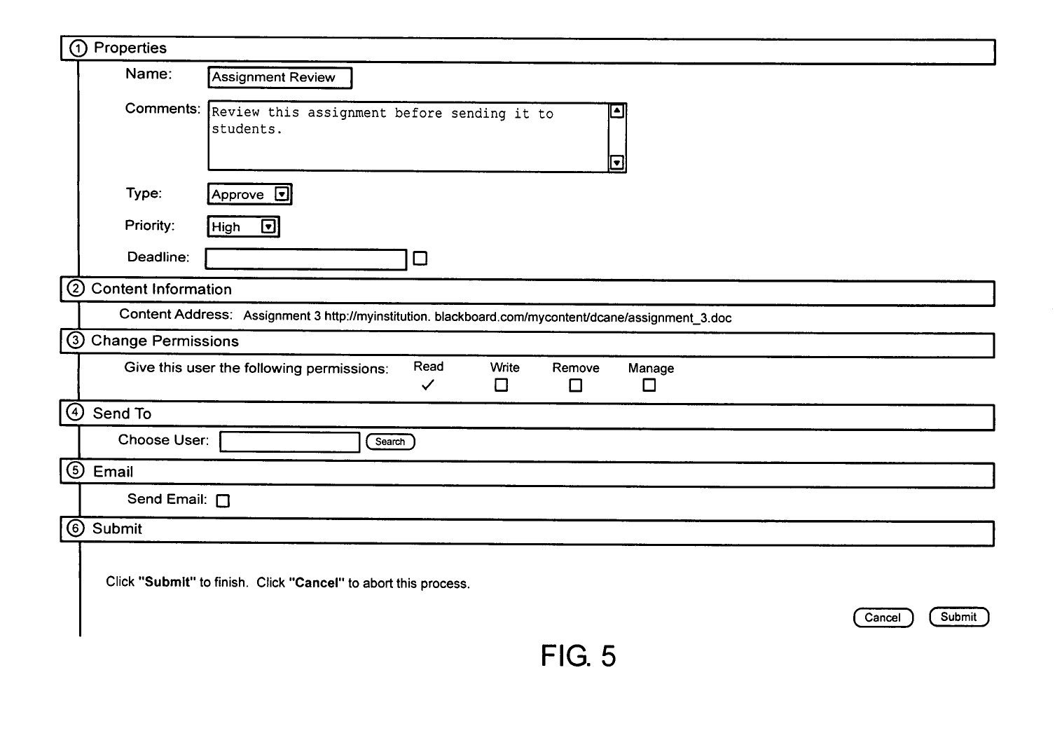

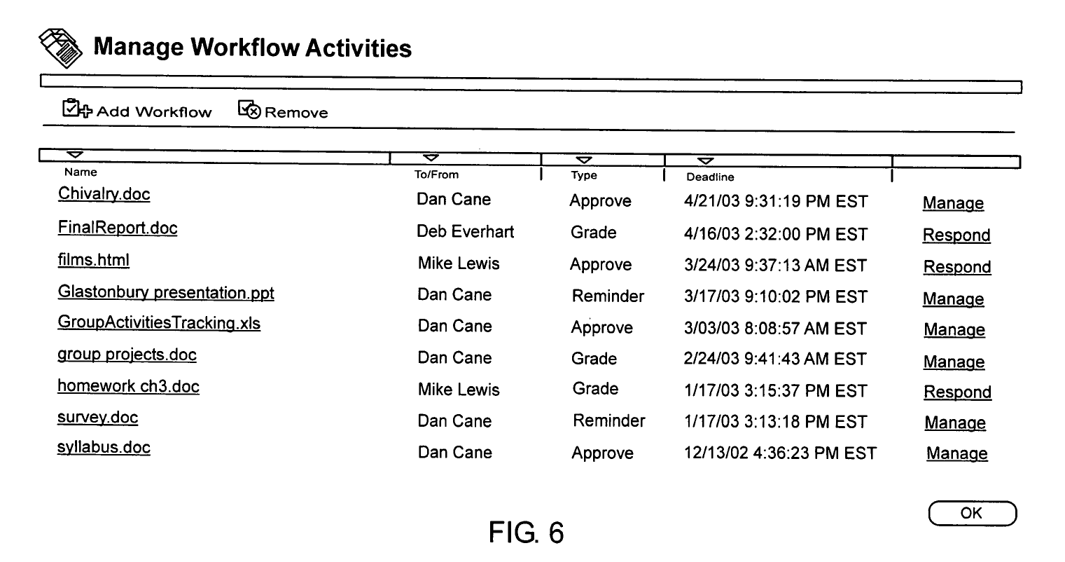

In addition, the content system can manage file versioning, monitor checkin/checkout, and be used as a workflow tool. Workflow refers to the process by which content items are transferred from one user to others for their actions. FIG. 5 is an exemplary screenshot of a workflow page for transferring content. FIG. 6 is an exemplary screenshot of a page for managing workflow activities.

As discussed in greater detail below, a content system in accordance with one or more embodiments of the invention can include (1) a virtual hard drive system, (2) a portfolio system, (3) a library content integration system, (4) an object catalog, and (5) a link checker.

Virtual Hard Drive

In accordance with one or more further embodiments of the invention, the content system can also include a virtual hard drive system, which serves as a content repository for storing content, managing access control to the content, and providing scalable and robust features for effectively managing content in an easy-to-use fashion. The virtual hard drive system is an Internet based secure file storage space for users. Users can access, browse, and share files via a Web user interface and/or WebDAV (Web Distributed Authoring and Versioning). WebDAV is a set of extensions to the HTTP protocol that allows users to collaboratively edit and manage files on remote Web servers. WebDAV can be an alternative to the Web user interface for managing files, including drag and drop functionality.

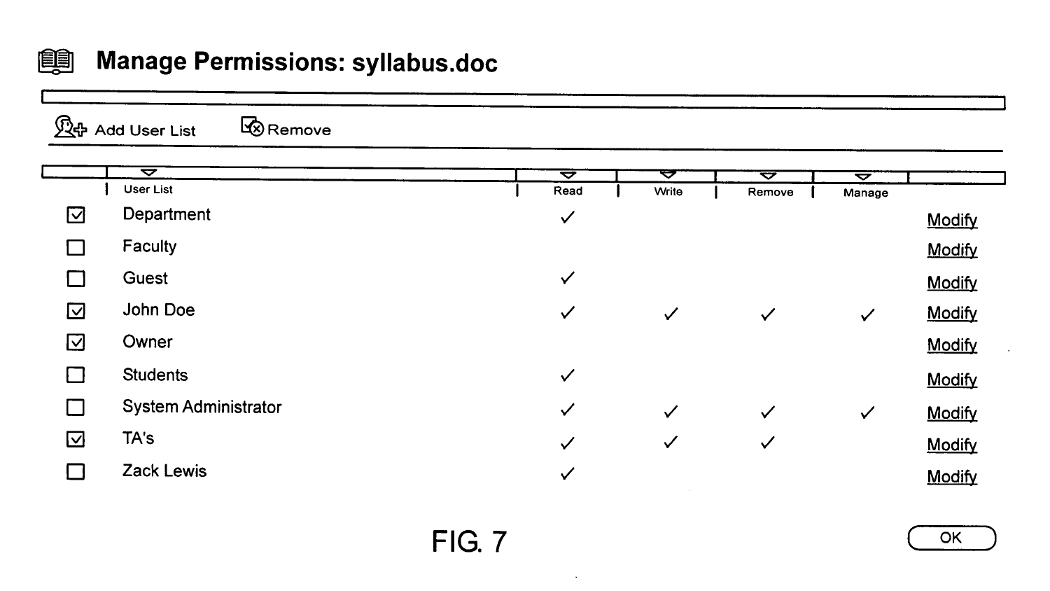

The virtual hard drive system can organize content into collections (such as individual collections, course collections, organization collections, and institutional collections). The collections act as distinct repositories of content that can be organized by creating folders. Access to collections or content can be controlled by permissions. Permissions can include read, write, delete, and manage, and can be set by individual users or user lists, which are collections of users. FIG. 7 is an exemplary screenshot illustrating permission management.

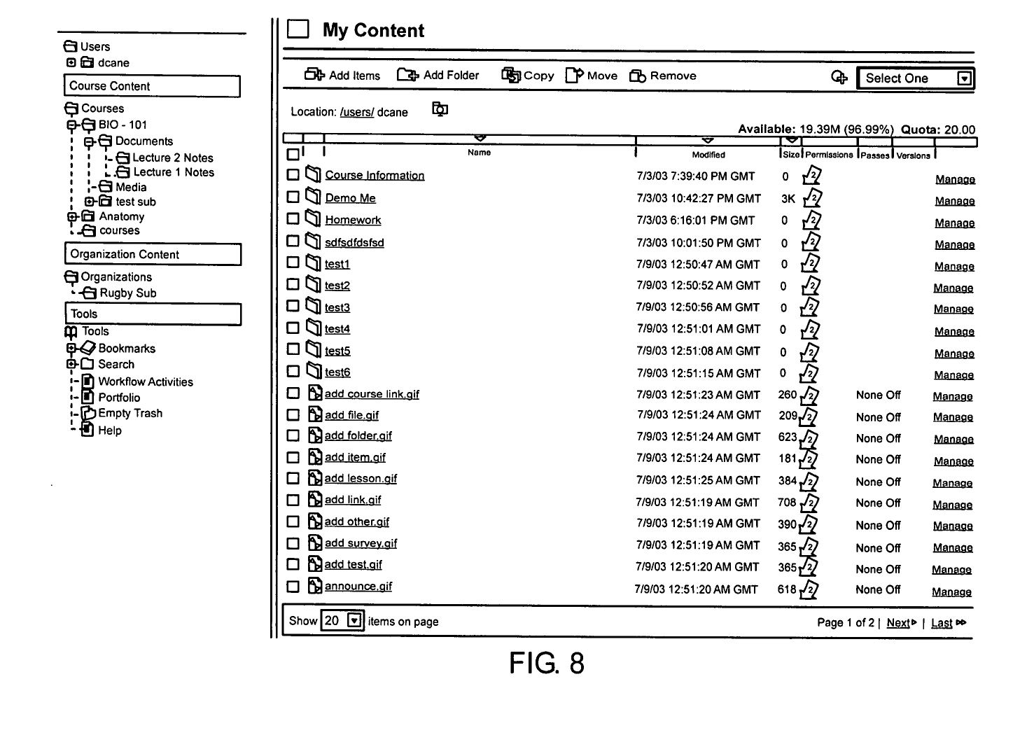

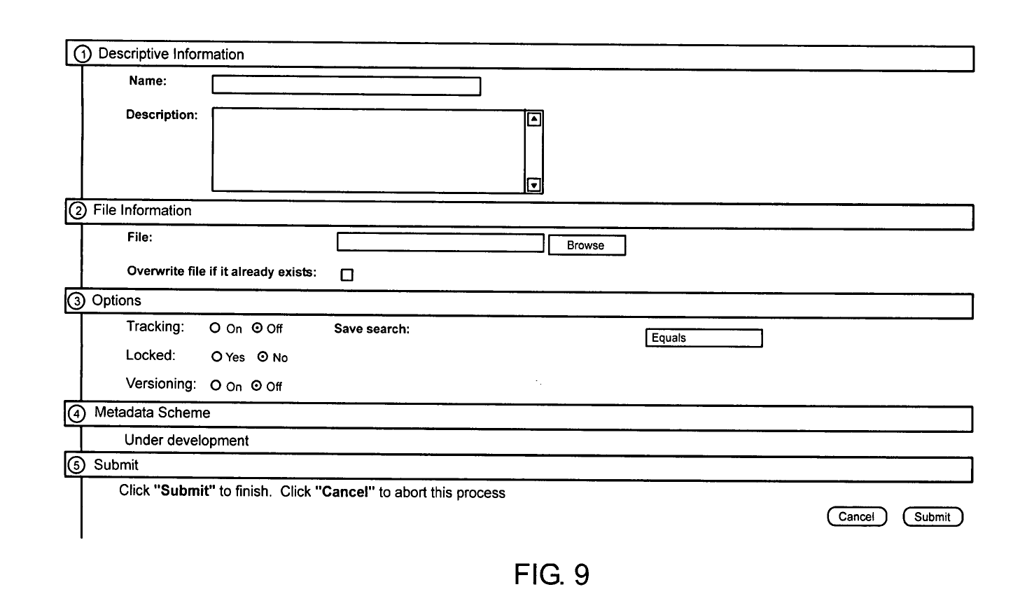

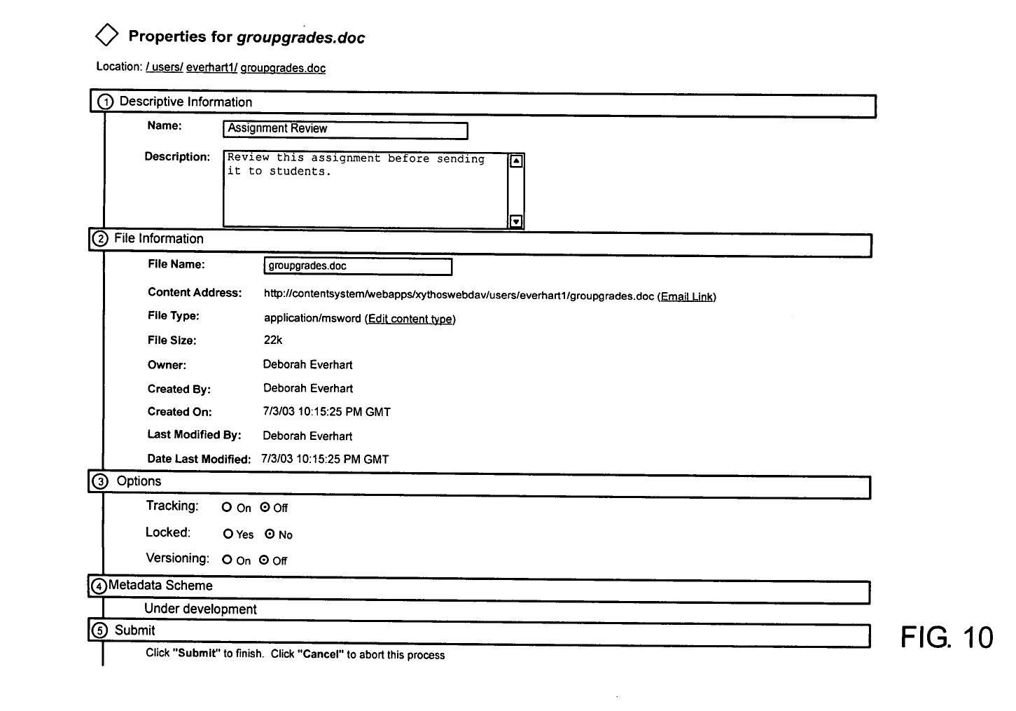

FIG. 8 is an exemplary screenshot of a directory listing in the content system for a user. Content can be in public or private files. The user can expand folders to display subfolders and lists. Users can store files, organize files (using folders), and share files from their “My Content” area. FIG. 9 is an exemplary screenshot illustrating how a content item can be added to My Content. FIG. 10 is a screenshot illustrating how properties can be set for added content.

In accordance with one or more embodiments of the invention, different storage quotas and bandwidth control can be provided for different groups of users. For instance, students can be provided 20 MB of storage space and faculty can be provided 40 MB of storage space. Disk quotas and bandwidth controls can also be based on individual directories, e.g., a course directory. The virtual hard drive system can enforce disk quotas and bandwidth controls set by administrators.

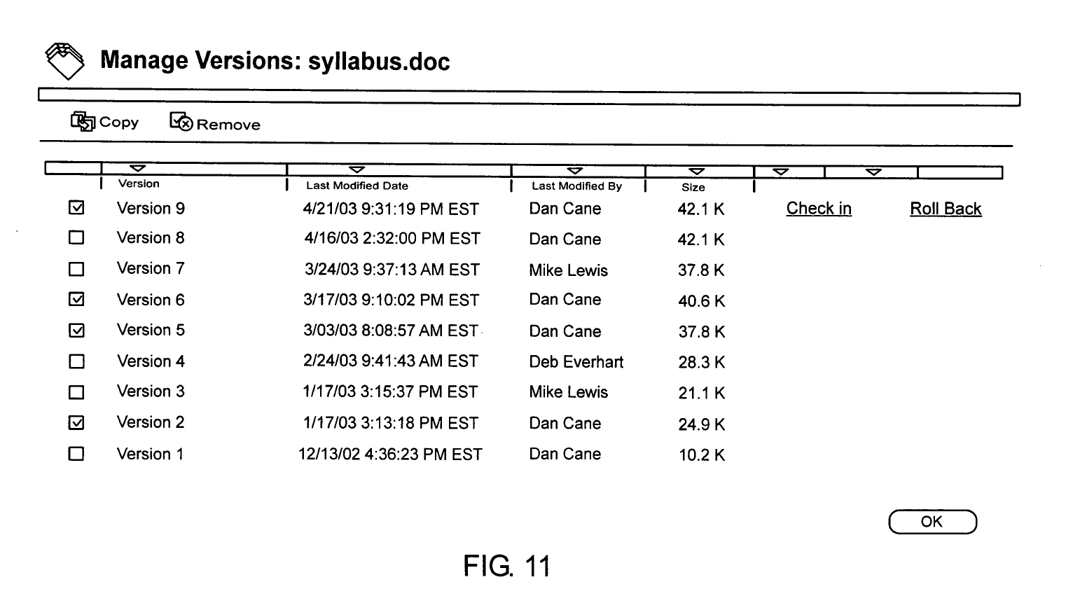

The virtual hard drive system preferably allows versioning of stored content, which enables multiple versions of a single document or file to be stored and a history of changes viewed. FIG. 11 is an exemplary screenshot illustrating management of versions of a document or file.

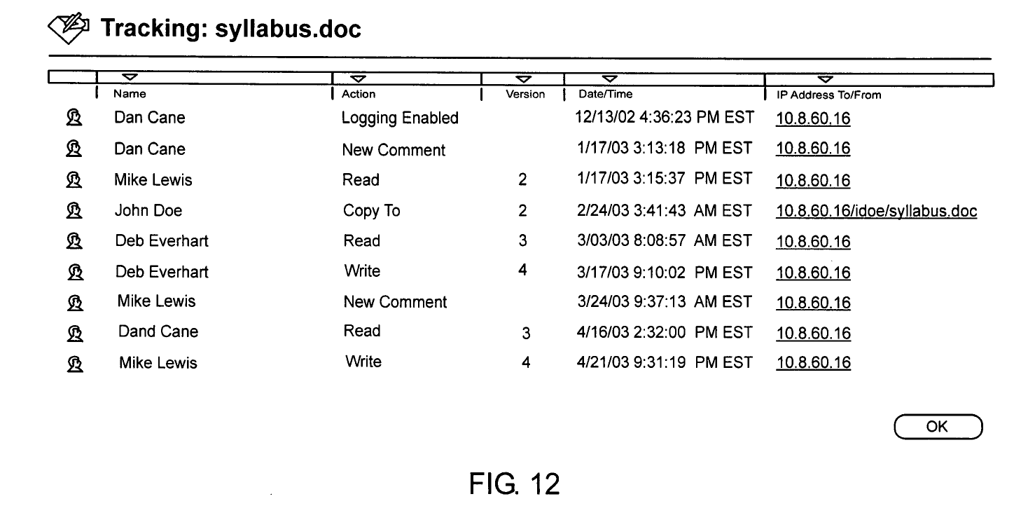

Files in the content system can preferably be tracked to monitor which user took what action (e.g., read, copied) with respect to the file. FIG. 12 is an exemplary screenshot illustrating tracking.

Portfolio System

In accordance with one or more further embodiments of the invention, the content system can include a portfolio system, which allows users such as students and faculty to create online portfolios. A portfolio is a compilation of materials a user can make available to others via a Web page, typically for specific purposes such as, e.g., a job search. The user can give a particular portfolio a specific name (e.g., “My Resume” or “My Stuff”). Portfolios can include personal portfolios (used, e.g., in a job search or graduate school application), course portfolios (e.g., a compilation of work submitted by a student to an instructor at the end of a term), portfolios of student work submitted by instructors to administration, and collaborative and other portfolios.

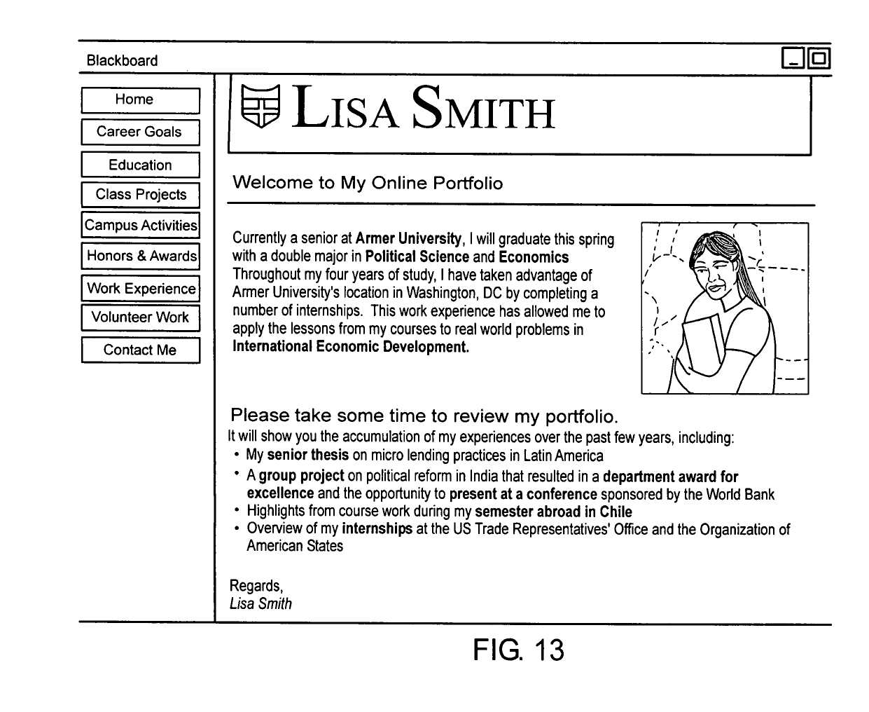

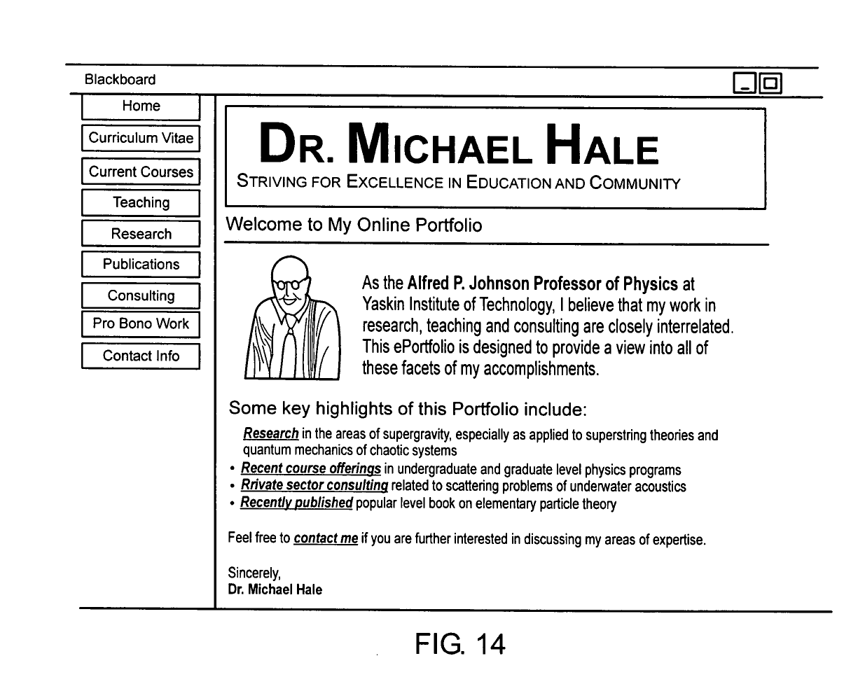

The system allows users to create multiple portfolios based on intended audiences. For example, a student can create one portfolio for potential employers and another portfolio for use in graduate school applications. Student portfolios can include, e.g., material describing courses taken, projects, and work experiences. FIG. 13 is an example screenshot of a student portfolio. Faculty portfolios can include, published papers and descriptions of research. FIG. 14 is an example screenshot of an portfolio of a faculty member.

The portfolios can be shared with users both inside and outside of the institution. Access to the portfolios can be restricted, e.g., for a specific number of views or for a specific length of time.

The portfolios can be created without the need for knowledge of HTML use using a “Wizard” style creation and selection of portfolio content. Users are provided with templated layouts that can be easily filled with desired content.

Library Content Integration System

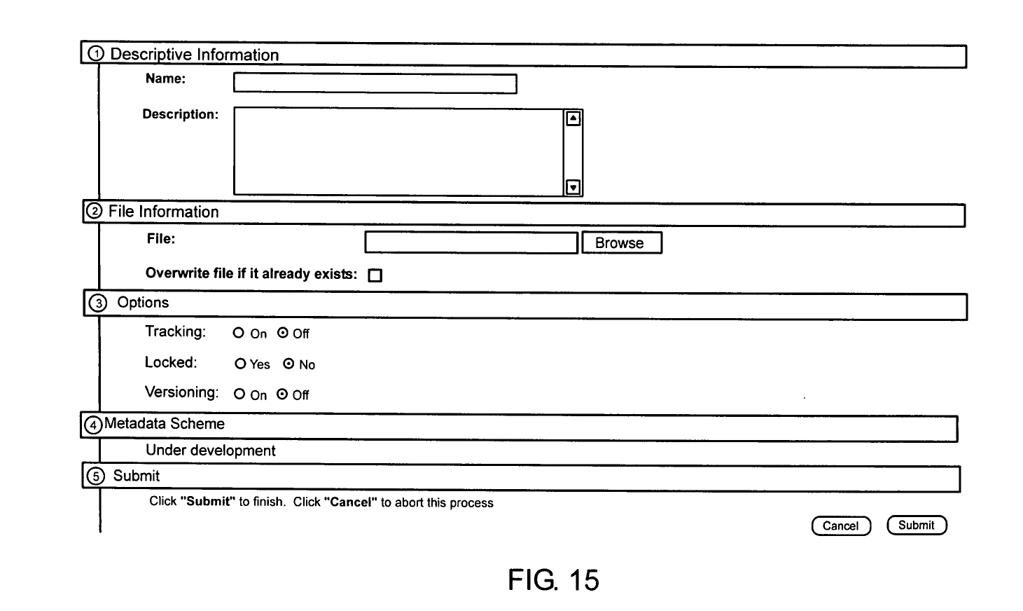

In accordance with one or more further embodiments of the invention, the content system can include the ability to integrate library content or resources into courses. This allows librarians to manage library related content in course files. For example, a librarian can place content into folders of a particular course, e.g., copyright cleared materials that are on reserve for students enrolled in that course. FIG. 15 is an exemplary screenshot illustrating addition of content items on reserve. Preferably, the librarian cannot make changes to other areas of the course content. The content added to folders can be tagged with standard metadata, e.g., Dublin Core and IMS.

The learning system and the portal system can implement a role-based system that is attached to each user. The content system preferably honors these roles and display interface elements in the correct context based on the roles.

The learning system and portal system roles can be mapped into a user list infrastructure within the content system. These can include course roles, portal roles, and system roles. The learning system course groups can be mapped into “group” infrastructure within the content system.

For example, an instructor logs into the learning system, and clicks through to his or her course control panel. He or she then creates a course content item that is linked to the course content selection within the content system. She or he then browses to the course content collection. The content system has already mapped the instructor role of this course to the proper permissions structure for the course content collection, thereby granting access to the instructor to read, modify, or remove any files within the course content area.

Users of the content system can protect their documents from others gaining access. Users can give others selective access to files or folders in the “My Content” area. Each file and folder can have, e.g., Read, Modify, and Delete permissions. Users can have the ability to share each folder and file with other users or user lists. For example, consider a user who wants to share a particular file with a peer. The user can locate the files by browsing to the file in his or her collection view, click on a button to display the permissions, and then add the user that he or she wants to give access to. For each user (or user list), the owner can set the Read/Modify/Delete permissions.

Also, e.g., a student might want to protect a few of his or her personal files. The student can locate the files, click to view the permissions, then remove all users and user lists that have access to the file. Alternatively, the student simply removes permissions for all users and user lists.

In order to reduce mistakes with setting permissions on folders, the content system can support inheritable permissions within a folder tree. More specifically, permissions that are setup on a folder can be recursively applied to all children of the parent folder.

The content system can allow access and linking to discrete versions of files, e.g., the latest version of a file can be specified or some given earlier versions, if so desired.

The content system can allow all content within a collection to be web-accessible with a single URL, so that users can cut and paste URL links to share documents and reference materials that are stored within the collections.

The content system preferably “tags” each piece of content with metadata in order to effectively track and identify content within the system. The content system preferably implements industry-standard metadata schemes such as, e.g., those put forth by the IMS.

Institutions need to limit any abuse and misuse of content storage space with regards to file storage allocation. The content system accordingly can support quotas for each individual stored collection, so that users cannot store extraordinary amount of data (e.g., a student's entire mp3 archive) and share it out to the campus. Quotas can preferably be enforced from both the Web interface as well as the WebDAV interface. The content system administrator is preferably able to universally set quotas for all collections in the system. The administrator can preferably identify a single collection and manually set the quota to any value. If desired, quotas can be applied to folders, not users.

The content system can have a mechanism to allow a system administrator to view the amount of content that is stored within the content system, and obtain more detailed views of content usage, especially as it pertains to quotas. Quota reports generated by the system can show system-wide quota allotment versus used space. The quota reports can allow the administrator to search for particular collections and deliver a summary of quota and disk usage for the collections selected.

Users may want to be able to share certain distinct pieces of content with users that do not have an account within the content system. The content system can support a pass-based system that safely allows non-network members to access content. The passes that are generated can be sent to the destination user as a URL, and provide either time-based or number of use-based access to the designated content item.

Content system users collaborating on a project can have the ability to work together on the same file instead of sending multiple copies back and forth to determine which changes were made to which version. The content system can support basic file versioning with a history feature to view revision details. The content system can preferably support an unlimited number of revisions per content item. The revisions can include a “comments” meta-data attribute that can contain user specified comments about the particular revision.

For effective document collaboration, the content system can allow users to have the ability to “check out” a file to be worked on, effectively giving them the exclusive ability to modify that particular file. This keeps others from being able to modify the file. The content system can support “check-in” and “check-out” of content. Upon check-out, the content item effectively becomes “read-only” for any other user other than the one that has the item checked out. Upon check-in, the content can automatically be committed as a new revision. Upon check-in, the user can have an opportunity to fill in the “comments” field. The content system can provide a facility for “undo-checkout,” which checks the content item back in but does not execute a new revision.

The content system can allow each user an area to view the status of any tasks he or she needs to complete or participate in for improved implementation of workflow. The content system can provide a robust “My Activities” tool, where the user can go to view all the workflow-related tasks he or she needs to complete. The “My Activities” area can be an aggregate view of all workflow-related tasks that the user has waiting for him or her. The “My Activities” area can be available as a Portal Module at the Portal level for quick access and referral by the user.

The content system can allow users (instructors and students) to participate in a two-step workflow, that involves Party A sending an item to Party B for review. Upon review, Party B can “return” the item to Party A. The content system allows for a two-way exchange to occur, where the status of the task is tracked, and both initiator and reviewer can view the status of the workflow at any time. The content system can provide a way to access workflow data from within the course, preferably at the course content item.

The content system can allow users to expose designated “subsections” or individual content items in a portfolio context. Building off of the permissions and pass-based control infrastructure, the content system can provide a mechanism (Web-based and e-mail) that simplifies the task of “assembling” and “publishing” the individual's portfolio. The user can designate specific folders or items. A portfolio wizard can build a webpage that aggregates all of the selected links into a single view, with a unique name for each portfolio. Each user can preferably be able to create an unlimited number of portfolios. Each portfolio can have a name, description, availability indicator, and offer customization options to the user.

For parity between the learning system user population and the content system population, users existing in a learning system such as the Blackboard Learning System preferably also exist in the content system.

Users of the learning system, the portal system, and the content system can have a generally seamless experience without ever having to re-authenticate. For full compatibility with other Blackboard products, the content system can generally seamlessly support all the authentication protocols supported by the Blackboard platform. WebDAV access can require re-authentication and may restrict the forms of authentication possible. Also, content system users who have authenticated into the learning system should not have to re-authenticate into the content system.

In order to more easily integrate the content system with a pre-existing learning system, a mechanism can be provided to allow existing course content to be moved into the content system. A conversion tool can be provided that allows course data to be moved from the learning system into the content system. This is preferably implemented using the content APIs, if possible

The content system can archive/restore the content stored in the system. A content exchange engine can be provided to support archive/restore of “My Content” and “Course Content” into and out of the content system.

The content system can have a search capability that includes full-text search of Microsoft Word, Excel, PowerPoint and other documents and on the meta-data that accompanies content within the content system. The search can be restricted down to an individual's collection but be as wide as the entire system. Search results can be returned in ranked order.

As previously mentioned, institutions need to limit any abuse and misuse of content storage space with regards to file storage allocation. By regulating the bandwidth in and out of any particular collection, the System Administrator can effectively throttle the amount of data that can be accessed within any particular collection. For each collection, the content system can preferably measure the amount of data that has been uploaded/downloaded within a variable time period (e.g., day, week, month). The time periods can be flexible enough to support a date range in increments of day, week, or month. The content system can have bandwidth reporting capabilities for the System Administrator.

In order to provide increased extensibility, the content system can provide APIs into metadata.

In order to minimize the impact to integration with the learning system, but still deliver a seamless, integrated environment for the learning system and the content system, an integration agent can be provided that allows instructors to add content from their “My Content” or “Course Content” areas from within the content system. Students and faculty can be provided with areas within the course and portal environment (e.g., Tools) to enter their “My Content” area.

A building block can be provided that contains a new Content Type with a content address link. Launch points can be implemented as System Tools for (a) My Content, (b) Course Content, (c) Institution Content, and (d) My Activities. Launch points can be implemented as a Portal Tool and Portal Modules for (a) My Content Module and (b) My Activities Module. Launch points can be implemented as a Course Tool for Course Content. One or more new portal module types can be provided that access content from the Content System (e.g., to include an image in the module or link to a Content System file).

Content Catalog

In accordance with one or more embodiments of the invention, a content catalog is provided that allows users to easily reuse and share content among a broad audience. The catalog allows users to electronically search the catalog or browse by category to find content items they might wish to use.

The catalog can include user facing functionality that allows users to nominate their items for inclusion in internal and/or public catalogs. Users can use the catalog to browse, view and select items therefrom. In accordance with one or more embodiments of the invention, an administrator can have control over catalog categories and availability on the system.

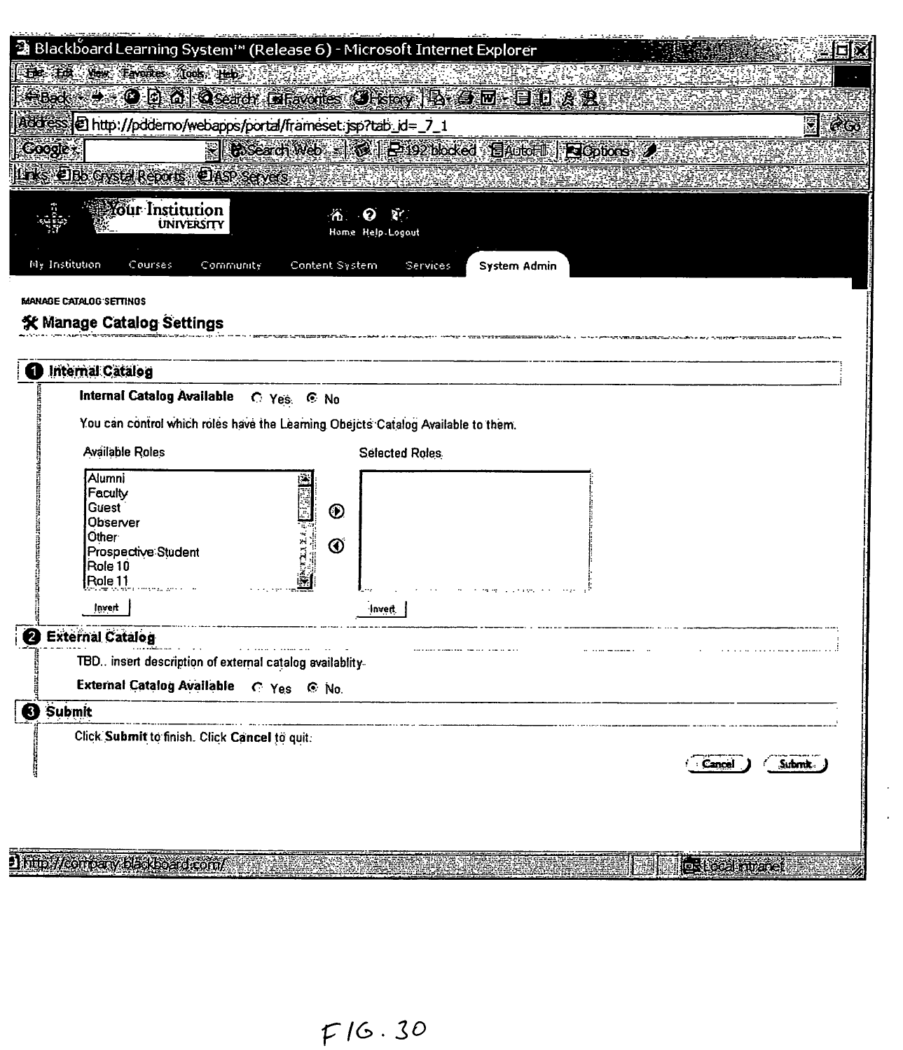

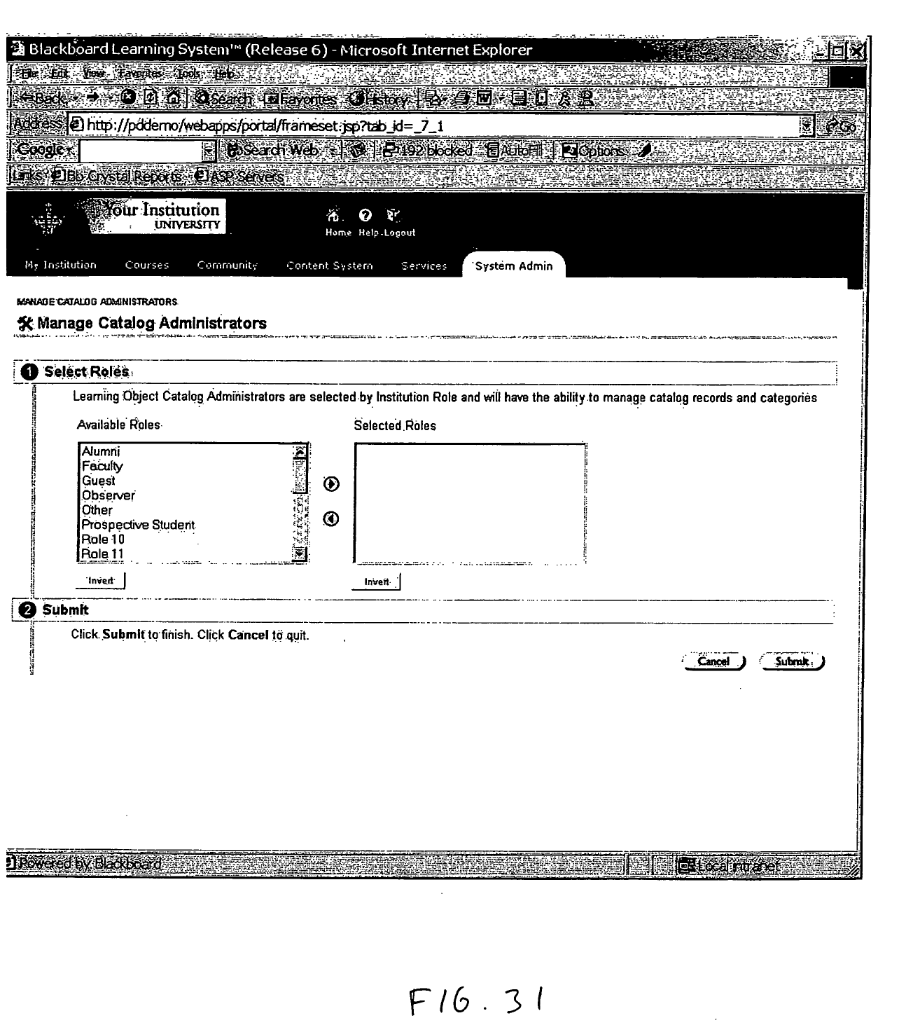

The catalog is preferably accessible from a content system menu. System Administrators can control who can access the catalog, e.g., by the institution role of the user. For example, a school might not allow alumni users to browse the catalog. FIG. 30 is an exemplary screenshot illustrating a manage catalog settings page in accordance with one or more embodiments of the invention. From this page, an administrator can specify and control which user roles have accessibility to a given catalog.

Catalog entries can be found, e.g., by searching for a desired entry using its name or other metadata associated with the entry or by browsing the categories. Category creation is described in further detail below.

In accordance with one or more embodiments of the invention, a system administrator can specify who can submit catalog entries, e.g., by institution role. For instance, a school might not allow students to submit entries to the catalog.

A variety of items may be added to the catalog. A catalog entry can be created for an individual file in the content system (such as, e.g., a Shockwave file) or an entire folder (which might be used if a web site is the content object). Users can access, e.g., a “Manage Catalog Entries” page from a “Modify” link on any item or folder for which they have manage permission. From this page, they can create a catalog entry, modify an existing entry, or remove their entry from the catalog.

A catalog entry is a wrapper containing information about a given content item. Users can select a category for their catalog entry and fill in basic information such as, e.g., name, authors, description, keywords and learning objectives. All of this information can be drawn from the metadata for the item itself (if that has been filled in), but can be distinct from that metadata. This means that the description for the catalog can be different from the general description used in other contexts. Users can create and manage multiple entries for a single item.

In accordance with one or more embodiments of the invention, a catalog entry can be submitted to more than one category. Users can create multiple catalog entries for an item or folder. Each catalog entry is preferably managed separately by the user, and it can be approved separately by a so called catalog manager. This means that while the item might be rejected for one catalog category, it could be accepted for another.

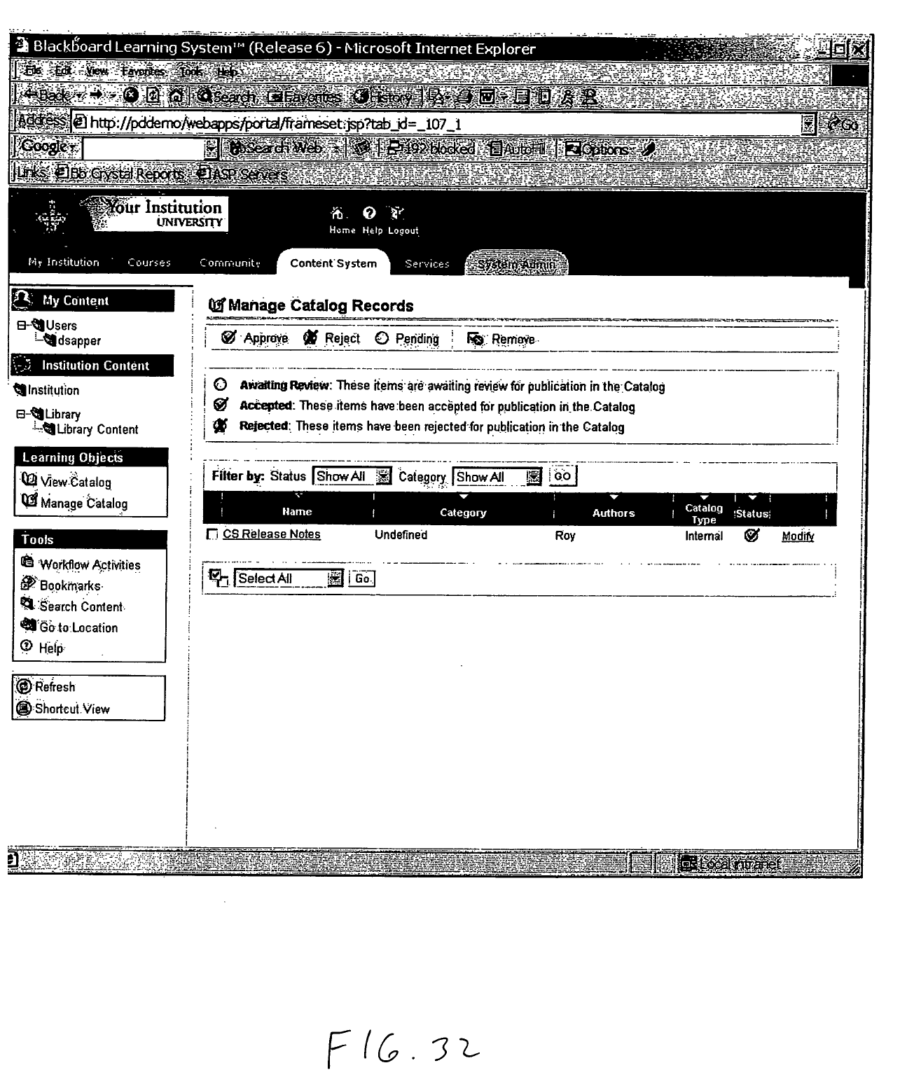

The catalog manager can be the system administrator or some other person designated for approving catalog entries. The system administrator can grant catalog manager status to other users by, e.g., institution role. Anyone on the system, regardless of course or system role, can be allowed to be a catalog manager as desired. It may be beneficial for catalog managers to be experts or otherwise knowledgeable in the subject matter in a field when reviewing catalog entries and creating catalog categories. The system administrator can create a new institution role for this function (e.g., catalog administrator) and assign that role as a secondary role to those users who should have this right. FIG. 31 is an exemplary screenshot illustrating selection of catalog administrators or managers in accordance with one or more embodiments of the invention. From this page, a system administrator can select catalog administrators by institution role to have the ability to manage catalog records and categories. Catalog administrators can approve or reject content submissions, and ensure proper categorization of the catalog.

FIG. 32 is an exemplary screenshot illustrating management of catalog records in accordance with one or more embodiments of the invention. From this page, a catalog manager can view the status of catalog entries, i.e., whether a given entry has been accepted, rejected, or is pending (awaiting review).

Catalog managers can preferably modify catalog entries from a Manage Catalog Entries page. They can change information about the item including the category to display the item in.

If a user modifies an item in the catalog, the catalog entry status can be returned to “pending.” This allows administrators to reclassify or possibly reject this new version.

Users can access status information from their “Manage Catalog Entries” page (available from the item or folder modify page). From this page they can see if their item is pending, accepted or rejected.

Catalog review responsibilities can be shared. Catalog managers can filter and sort entries to distribute review responsibilities according to whatever business rules are appropriate at a given school. For example, a school might have one catalog manager responsible for reviewing entries in the History category and another catalog manager responsible for reviewing entries in the Science category.

Catalog managers can create a very large set of high-level categories and sub-categories. For usability purposes, however, top-level categories can be limited to 50 or less and subcategories to 20 or less.

In accordance with one or more embodiments of the invention, a public catalog of content objects can also be provided. Users can select whether to make their items available in this public catalog when they create catalog entries. Otherwise, catalog entries are available internally only.

Internal catalog entries can grant read permission to generally all system accounts on the item or folder associated with the entry. Public catalog entries can grant read permission to the public on the item or folder associated with the entry.

If an item is moved or removed, an error can be displayed when a user clicks on the catalog entry in the catalog view. If permissions have been removed, the link can no longer be viewable by all system or public users.

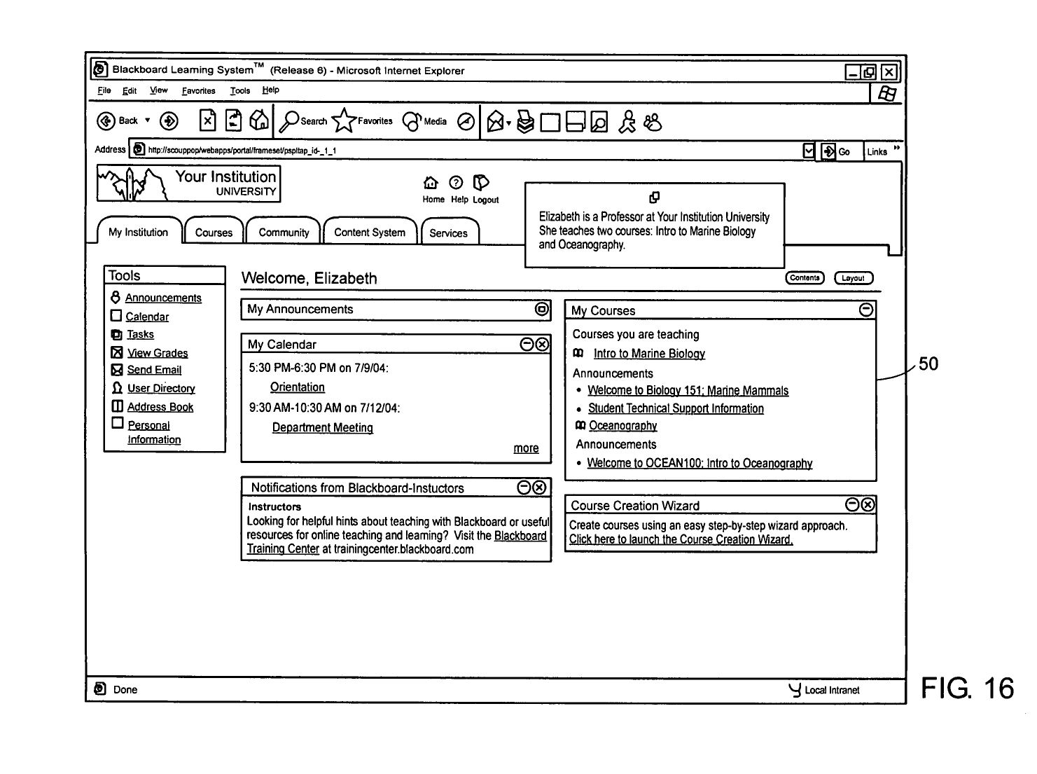

FIGS. 16-22 are sample screenshots illustrating one use case example of how a user (in this case, a college professor) searches for and finds a content item in the catalog and then adds the item to a set of course materials accessible by students taking a course. In these screenshots, pointer bubbles are used for annotation to provide further description about a particular item or action on the screen. Also, rectangular blocks are used to provide information about the scenario or background information used to describe the process.

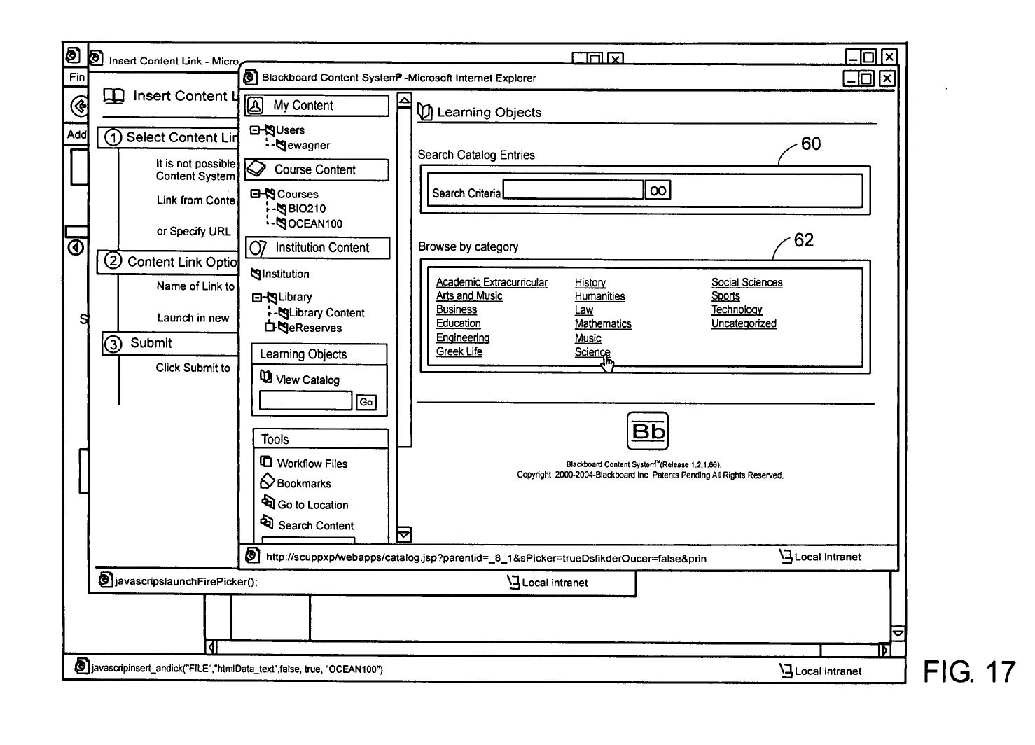

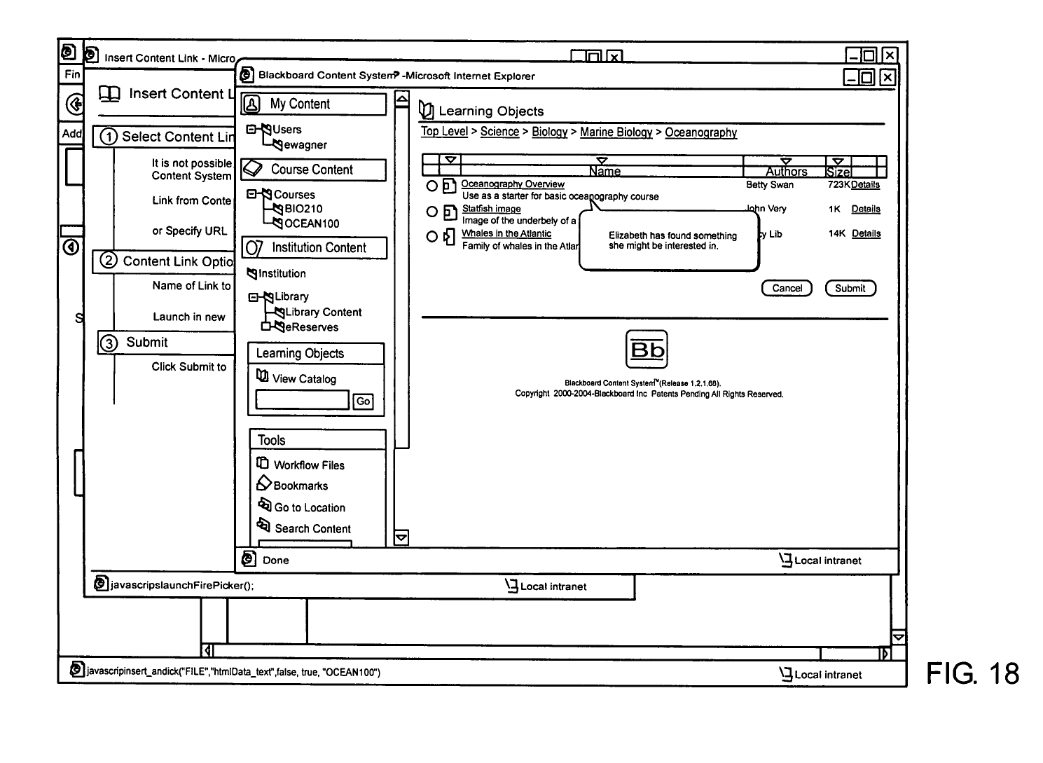

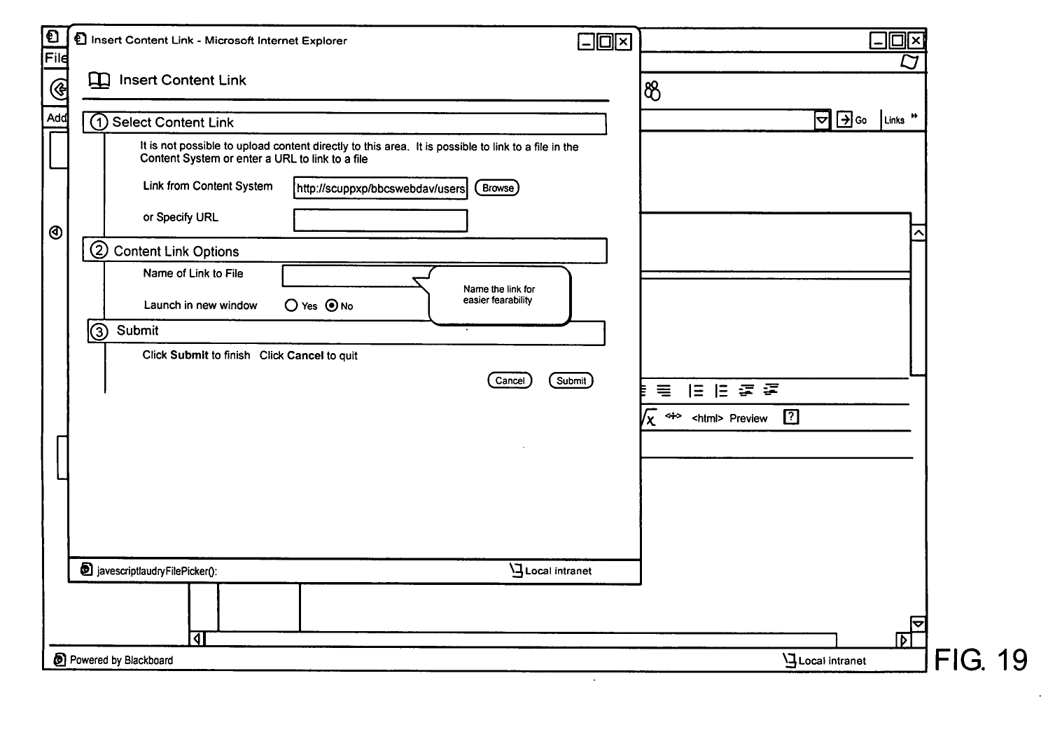

FIG. 16 is an example of a home page of a user (a professor named Elizabeth), which identifies in area 50 courses taught by her. She wishes to add to her course on oceanography an introductory article on the subject. She can then access the content system to look for such an article as illustrated in the exemplary screenshot of FIG. 17. As shown, she can perform a text search for catalog entries at 60 or browse by category at 62 (and various subcategories). FIG. 18 shows a content item selected by the user. FIG. 19 illustrates how the content item can be linked to the course.

Link Checker

In accordance with one or more further embodiments of the invention, a check links tool is provided to allow users to verify links to items in the content system. Links might break for two primary reasons. First, the item in the content system may have been renamed, moved, or deleted by someone with manage permission on the item. Second, all users (students, TAs, etc.) may not have permission to view the item. (Read permission is generally required, and is automatically added on the item's “Manage Permissions” page when a link is created, but someone may have inadvertently removed this permission.)

Users who click on a broken link receive an error. Users can receive a “File Not Found” error for broken links. For missing permissions, they can receive an “Access Denied” error.

The check links tool helps ensure that course, organization and portfolio users can access content that resides in the content system. The check links tool scans content areas and portfolio pages for broken links and reports the results. The check links tool is preferably accessible from a control panel of all courses and organizations in the content system or from the portfolio manage page. The system administrator can enable this tool from an administrator panel. Links can be designated as follows:

1. Valid link: All course users will be able to view the item when clicking on the link in the course or organization environment or from a portfolio.

2. Path not found: This will occur if the item (file or folder) in the content system has been renamed, moved, or deleted. Users can receive a “File Not Found” error. The course or organization builder (e.g., Instructor, TA or course builder) or portfolio creator can either return to the content system to replace the original file, or recreate the link in the course or portfolio to the new name/location in the content system.

3. Repairable permission error: The link to the item (the path) is valid, but read permission does not exist for all course users or all system accounts. For example, so even though the instructor or portfolio creator can view the item properly, students and other system users would receive an “Access Denied” error. The tool allows the instructor or portfolio creator to repair the permission error by clicking a “repair” button that can add the appropriate read permission back to the content system item.

4. Un-repairable permission error: The link to the item (the path) is valid, but read permission does not exist for all course users or all system accounts. Additionally, the user that ran the tool does not have manage permission for this item, so he or she cannot repair the permission problem like in the use case above. The user must contact someone (such as, e.g., the system administrator) with manage permission on the item to add the appropriate permission.

The check links tool can scan the validity of links in various areas including, e.g., the following:
1. Content areas (course documents, course information, syllabus, etc.)
2. Staff Information
3. Announcements, calendar events, tasks
4. Learning unit shells
5. Discussion boards (e.g., threads that have links to images residing in the content system)
6. Portfolios

The check links tool is particularly useful after copying, restoring, or importing courses or organizations or after copying a portfolio. The tool can be made available or unavailable in the Administrator Panel.

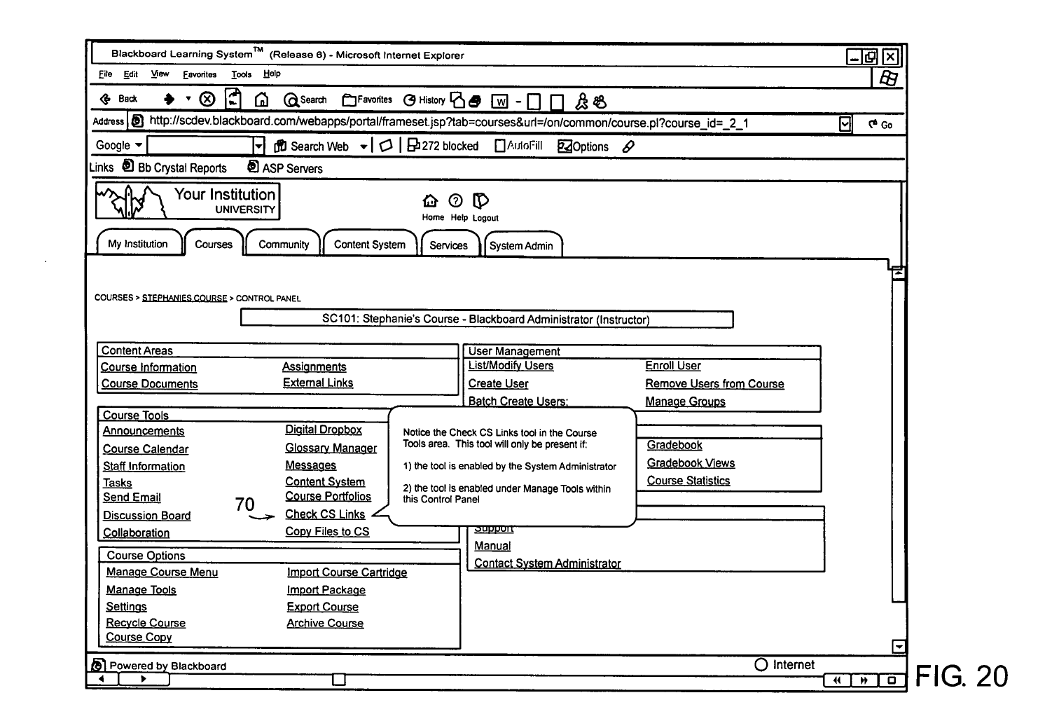

FIGS. 20-22 are sample screenshots illustrating one use case example of how a user can use a check links tool in accordance with one or more embodiments of the invention in the control panel of a course or organization. In these screenshots, pointer bubbles are used for annotation to provide further description about a particular item or action on the screen. Also, rectangular blocks are used to provide information about the scenario or background information used to describe the process.

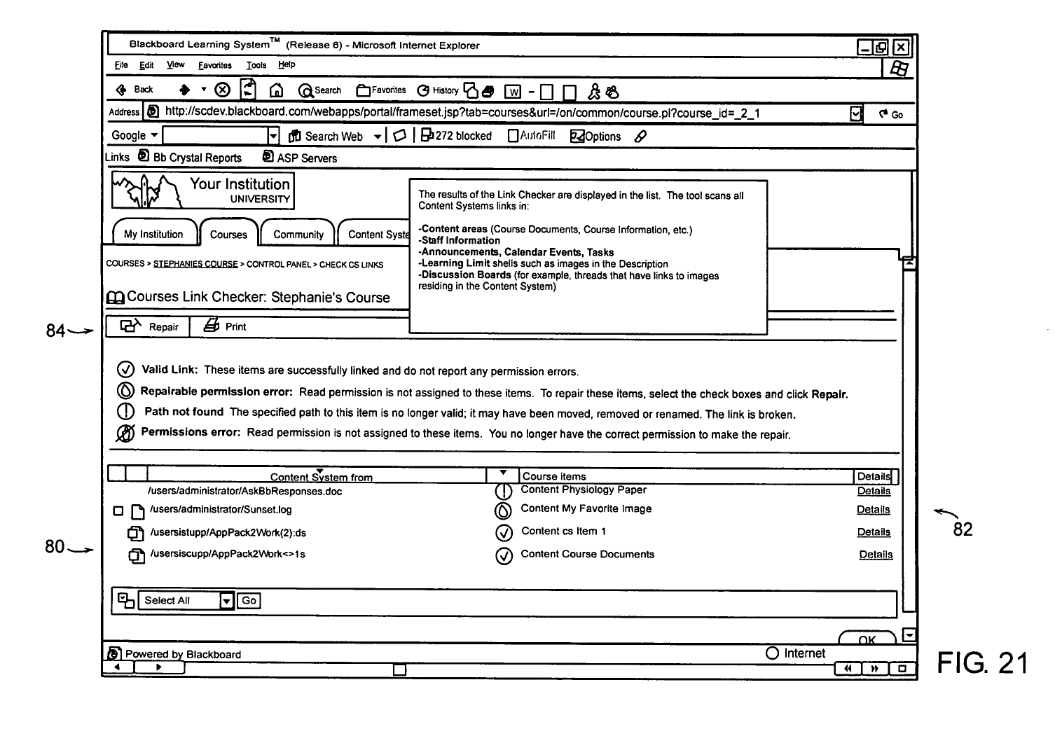

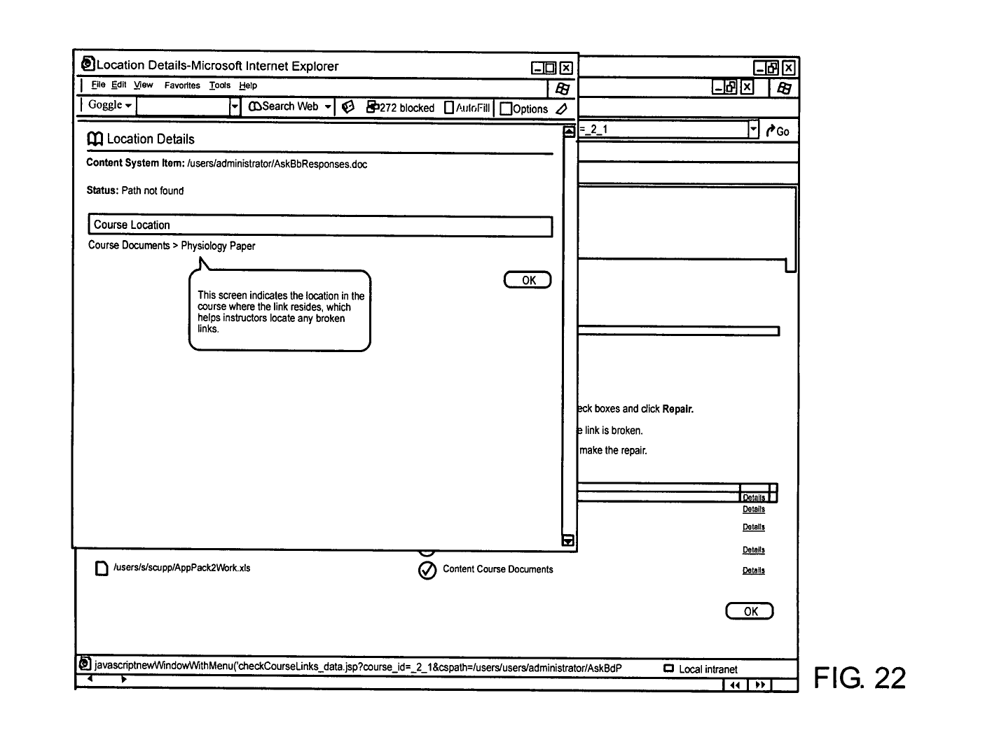

FIG. 20 is a screenshot illustrating the course tools available to a user, including the check links tool shown at 70. This tool can be selected to verify links in a course to content items in the content system as illustrated in the screenshot of FIG. 21. The screenshot displays content items and the condition of their links at 80. The details buttons 82 can be selected to provide further details about the location of the links as illustrated in FIG. 22. The repair button 84 (shown in FIG. 21) can be selected to repair repairable links.

The portal screenshot in FIG. 2 shows an exemplary university portal system from which content system 10 (FIG. 1) may be accessed. Referring to FIG. 2, there are a number of windows that are opened for a particular system user. These windows will provide information and links for the system user to fully integrate with the online computer-based educational system that is shown in FIG. 1. For example, the activation tabs for the portal system are shown as “My Institution” at 202, “Courses” at 204, “Community” at 206, “My Library” at 208, “My Content Activities “at 210, “Institutional Library” at 212, and “My Course Library” at 214. If the “My Institution” tab is activated, at least the windows shown in FIG. 2 will be displayed. These include “Tools” window 216, “My Library” window 218, “Courses” window 220, “My Course Content Activities” window 222, “My Organization Content Activities” window at 224. The links in these windows may be activated to obtain the desired information or take the desired action. If any of the other tabs are activated, it will separately provide the information commensurate with the tab. For example, if My Library tab 208 is activated, it will display My Library window 218 for the system user.

The portal system may also be configured to accommodate different constituents of an institution that are using the online computer-based educational system. More particularly, system user access may be controlled at system set-up or post set-up for modifying the branding and roles for system users. FIGS. 23-29 will be referred to regarding the portal system of the present invention for control of system user access.

Referring to FIG. 23 generally at 230, a screenshot is shown for managing the brands of a particular institution, which in this example, is the Massachusetts University system. The tabs at 232 generally show the access points to the online computer-based educational system through the portal system. As shown, there is the “My UMASS—Staff” tab at 234, which will be directed to the faculty, staff and others at the various UMass locations, the “IT—Staff” tab at 236, which will be directed to the information technology (IT) staff at the various UMass locations, the “My Content” tab at 238, which will be directed to the content of the UMass system, and the “System Admin” tab at 240, which will be directed for use by the system administrator for setting-up the system, and the control branding and role issues as they arise during operation of the online computer-based educational system. The System Admin tab would normally not be able to be activated by a normal system user but is reserved primarily for the system administrator or other trusted persons.

When the System Admin tab is activated, the “Administrative Panel” link at 242 is provided. The Administrative Panel link will allow selection of the “Manage Brands” link that when activated will display of all of the brands under the UMass system that are shown generally at 244. At 245, the system administrator may add or remove brands from the list at 244.

At 244, there are five brands shown for the UMass University system. These are meant to be exemplary only. For each brand, the brand name is shown at 246, the host name at 248, and the role, if any, at 250. The system also provides activation links for displaying the properties of each brand, e.g., “Properties” at 252, and for customizing the brand, e.g., “Customize” at 254.

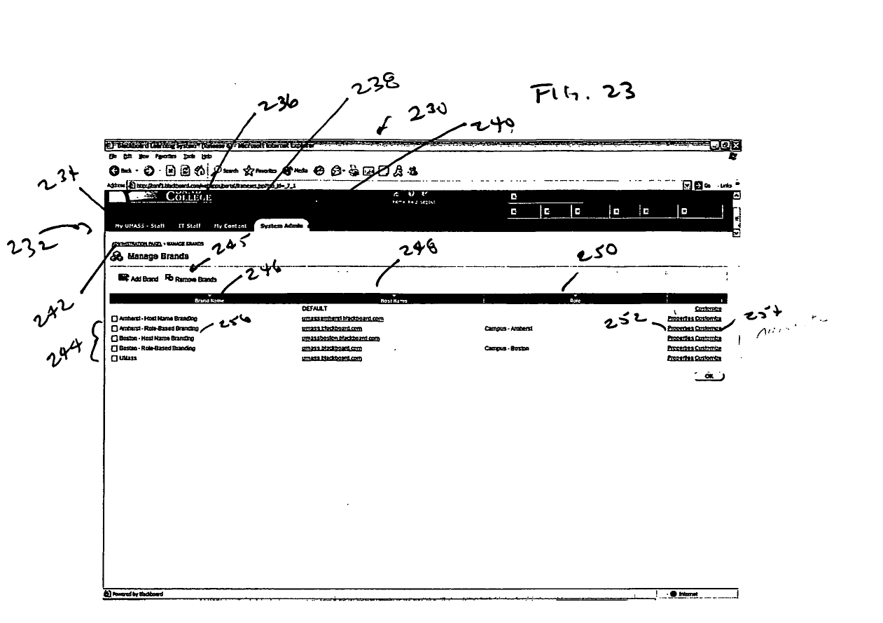

If the priorities link at 252 for the brand titled Amherst—Role-Based Branding” at 256 is activated, then the screenshot at FIG. 24 will be displayed. Referring to FIG. 24, generally at 260, the screenshot will display the properties of the selected brand and will permit the system administrator will have the ability to modify these properties if needed. If any modifications are made, the system administrator will submit them for changing the brand within the portal system.

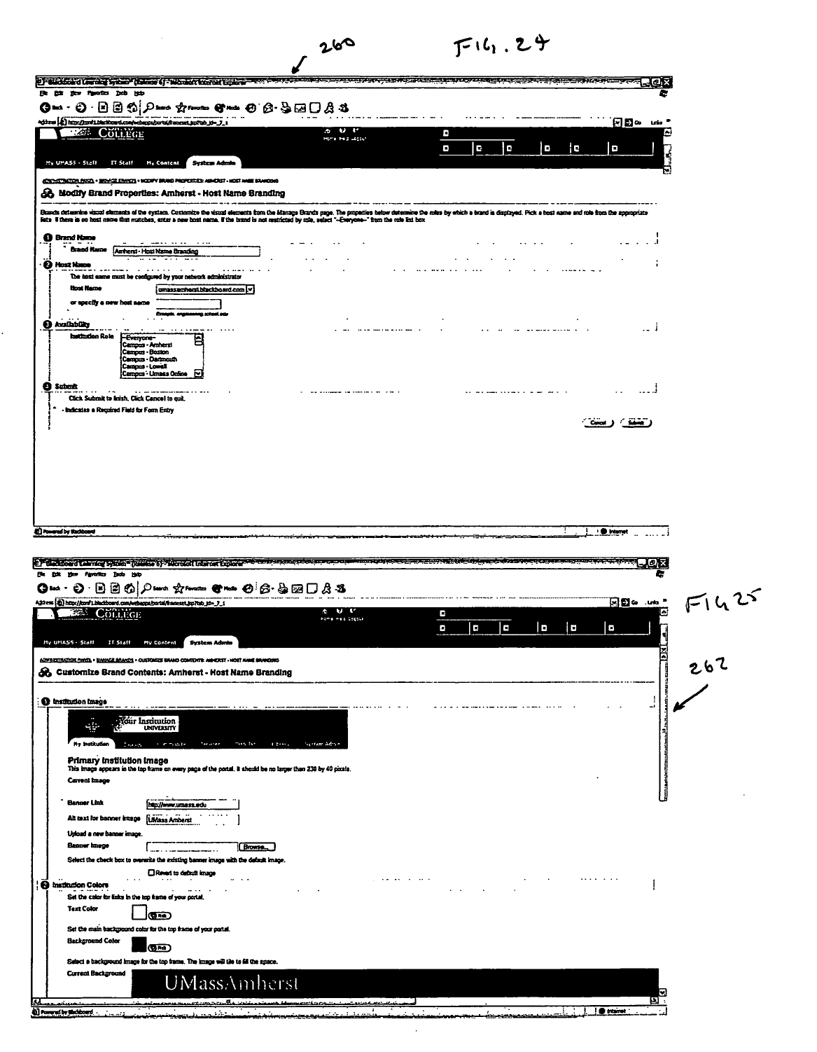

If the system administrator activates customize link 254 for the brand titled Amherst—Role-Based Branding” at 256, then the screenshot at FIG. 25 is displayed. Referring to FIG. 25, generally at 262, the information is displayed for customizing the institutional image and institutional colors that that will be displayed for the portal system screen displays. The system administrator will make these selections consistent with instructions from the portal system owner.

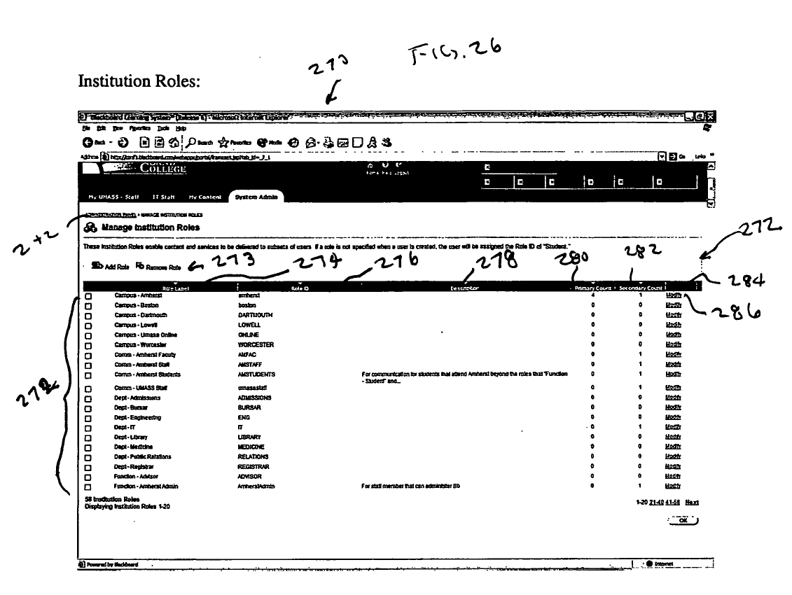

Referring to FIG. 26, generally at 270, a screenshot is shown for the managing the institutional roles for a brand. This screenshot is accessed when the “System Admin” tab at 240 is activated that will provide the “Administrative Panel” link at 242. This link will permit the selection of the “Manage Institutional Roles” link that when activated will display what is shown in FIG. 26 generally at 272. At 272, the various role labels that are available are shown at 274, the role IDs for those role labels are shown at 276, the description of a particular role, if any, is shown at 278, the primary role count for a role label is shown at 280, the secondary role count is shown at 282, and modify link for each role label is shown at 284. The system administrator can add or remove roles for the list at 272 by use of the controls at 273.

The primary and secondary role counts indicate the number of times that a particular role label has been selected in that category of role. For example the “Campus—Amherst” role label has been selected “4” times as a primary role and “1” time as a secondary role.

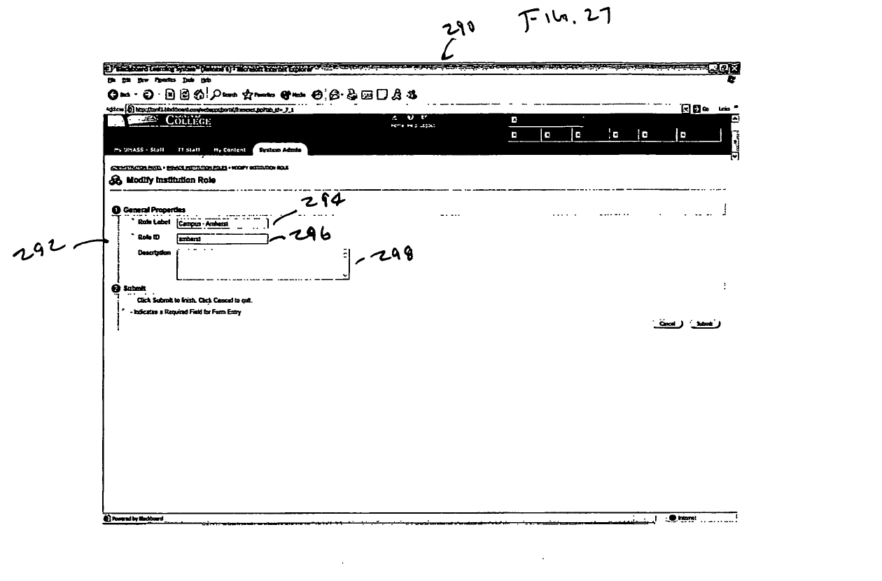

If the system administrator needs to modify a user role, it would activate, for example, the modify link 286 associated with the “Campus—Amherst” role label. When this happened, the screenshot at FIG. 27 will be displayed.

Referring to FIG. 27, generally at 290, the “Modify Institutional Roles” screenshot will display the general properties of the selected institutional role. This information is shown at 292. The system administrator may make changes to the roles by changing the role label at 294, the role ID at 296, or providing a description of the role at 298. If there are changes made, they may then be submitted to change the information for the appropriate system user and the content available for that system user also will be changed.

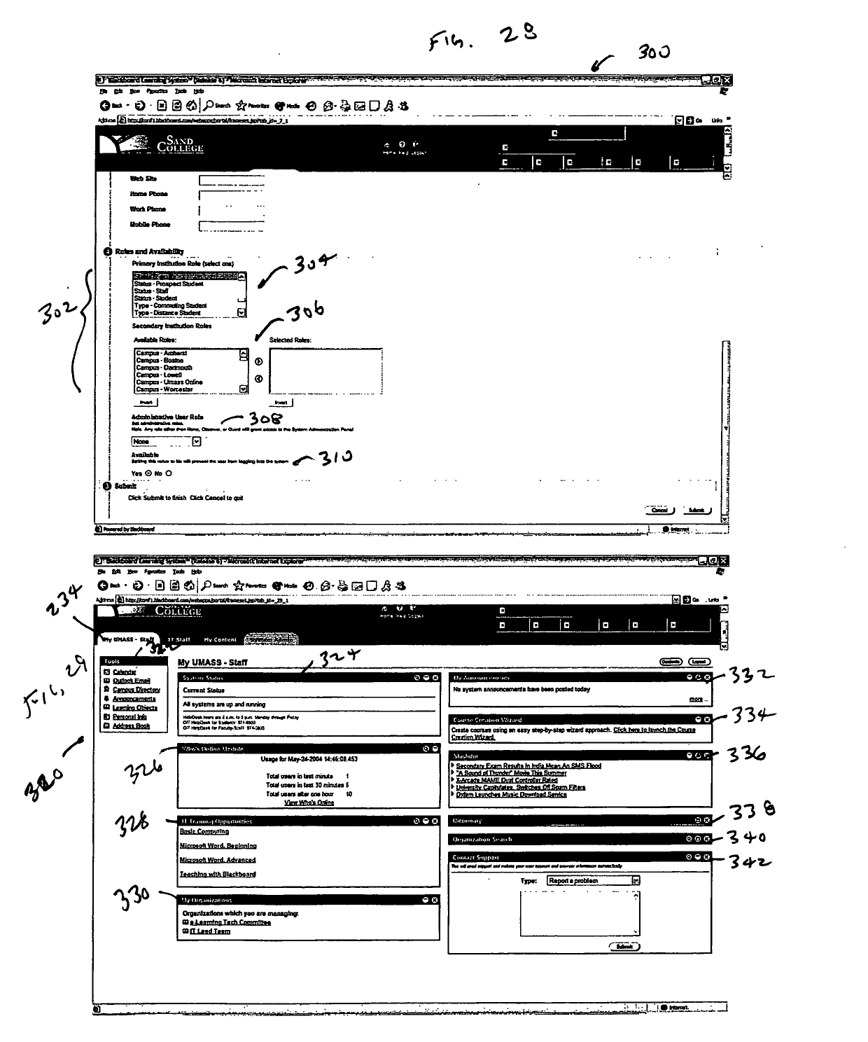

If there is a need for particular system users to have multiple primary and also secondary roles, the system administrator will activate “System Admin” tab at 240, which will provide the “Administrative Panel” link at 242. This will permit the selection of the appropriate link that will provide the screenshot shown in FIG. 28. Referring to FIG. 28, generally at 300, the screenshot provides the system administrator with the ability to define multiple primary and secondary roles for system users. This will permit a system user to receive content based on each of the defined multiple primary and secondary roles. As shown at 302, the system administrator may select primary roles and secondary roles at 304 and 306, respectively.

The portal system also permits the administrator to set the administrative user role at 308. The system administrator may select “None,” Observer,” or “Guest.” Any roles other than these will permit the user access to the Administrative Panel.

The screenshot in FIG. 28 also permits the system to be set for controlling a particular user's ability to log on through the portal system. If at 310 “No” is selected, the particular system user to which this information is directed will not be able to log on through the portal system. If it is set to “Yes,” that system user will be able to log on.

Once changes are made for the primary and secondary roles for a particular system user, these changes may be submitted to control the system user's use of the online computer-based system through the portal system.

FIG. 29, generally at 320, shows the screenshot that is provided if the “My UMASS—Staff” tab at 234 is selected. The screenshot at 320 will provide information for the faculty, staff, and others of the UMass system. The system users that would have access to the information shown in the screenshot also would have the ability to use the information displayed in the various windows. The information that is displayed is “Tools” window 322, “System Status” window 324, “Who's Online Module” window 326, “IT Training Opportunities” window 328, “My Organization” window 330, “My Announcements” window 332, “Course Creation Wizard” window 334, “Slashdot” window 336, “Dictionary” window 338, “Organizational Search” window at 340, and “Contact Support” window 32. This screenshot will permit the staff full integration with the system through the portal system.

Various content system tools and features described herein are preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as, e.g., an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to provide the specified functionality.

It should be noted that the various embodiments of the invention shown and described in this application are shown by way of illustration. As will be realized, the invention is capable of other and different embodiments and its several details may be capable of modifications in various respects, all without departing from the invention. Accordingly, the drawings and description herein are to be regarded as illustrative in nature and not in a restrictive or limiting sense.

1. In a system for providing a community of users access to content items, said content items relating to a plurality of courses, each user being associated with one or more of said courses, a method of managing and controlling access to said content items, the method comprising:
(a) receiving from one or more of said users proposed content items for inclusion in a content repository;
(b) selecting content items from said proposed content items for inclusion in said content repository;
(c) specifying which of said users are eligible to access which of said content items in said content repository; and
(d) providing access to content items in said repository over a network to users specified to have access to given content items.

2. The method of claim 1 wherein said network comprises a LAN, a WAN, a MAN, an intranet or the Internet.

3. The method of claim 1 wherein said users comprise students, instructors, administrators, or librarians associated with an educational institution.

4. The method of claim 1 further comprising allowing users to search for a desired content item in said content repository using metadata associated with said content items or using text searching.

5. The method of claim 1 wherein said content items are organized in a catalog, and wherein a desired content item can be identified by a user by browsing said catalog.

6. The method of claim 1 wherein step (c) comprises associating permissions with said content items.

7. The method of claim 6 wherein said permissions include read, write, delete, or manage.

8. The method of claim 1 further comprising controlling the time period said content items can be accessed by said users.

9. The method of claim 1 wherein said content repository provides a common structure for storage of said content items.

10. The method of claim 1 further comprising managing file versioning of content items in said content repository.

11. The method of claim 1 further comprising monitoring the checking in and checking out of content items.

12. The method of claim 1 further comprising managing workflow activities relating to content items in said content repository.

13. A portal system for user access to an online computer-based educational system, the portal system comprising:
an interface for communications with a system user;
means for providing a system user access to at least a content system of the online computer-based educational system;
means for managing branding for a plurality of brands available for system users to control at least a first level of access for system users using the portal system to content of the content system of the online computer-based educational system, and
means for managing a plurality of roles available for system users to control at least a second level of access for system users using the portal system to content of the content system of the online computer-based educational system.

14. The portal system as recited in claim 13, wherein the means for managing branding includes a capability to modify branding for a particular system user once it has been created.

15. The portal system as recited in claim 13, wherein the means for managing roles includes a capability to modify a role for a particular system user once it has been created.

16. The portal system as recited in claim 15, wherein a particular system user may have a single assigned primary role.

17. The portal system as recited in claim 15, wherein a particular system user may have a single assigned secondary role.

18. The portal system as recited in claim 15, wherein a particular system user may have a multiple assigned primary roles.

19. The portal system as recited in claim 15, wherein a particular system user may have at least one assigned primary role and at least one assigned secondary role.
